(19) United States
(12) Patent Application Publication
(10) Pub. No.: US 2008/0030800 A1
(43) Pub. Date: Feb. 7, 2008

(54) Electronic document management system

(76) Inventors: Shigeru Matsukawa, Osaka (JP); Ikuo Yoshida, Kanagawa (JP); Koichi Nagoshi, Tokyo (JP)

Correspondence Address: WENDEROTH, LIND & PONACK L.L.P., 2033 K. STREET, NW, SUITE 800, WASHINGTON, DC, 20006, US

(21) Appl. No.: 11/730,138

(22) Filed: Mar. 29, 2007

(30) Foreign Application Priority Data
Apr. 26, 2006 (JP) 2006-121478

(51) Int. Cl. H04N 1/04

(52) U.S. Cl. 358/474

(57) ABSTRACT

Provided is an electronic document management system which sorts out and stores electronic documents automatically. The electronic document management system displays the management names on a console panel of an image scanner, which are associated with document management information and pre-stored in an electronic document management server. When a user selects a given management name, an electronic document is processed in accordance with the management method associated with the selected management name. This allows electronic documents to be sorted out and stored automatically in accordance with the management method desired by a user, without the necessity of using any identification document.

### BACKGROUND OF THE INVENTION

(1) Field of the Invention

The present invention relates to an electronic document management system which sorts out and stores electronic documents automatically.

(2) Description of the Related Art

Electronic document management systems aim to save space for storing paper documents produced or supplied in large quantities in a location such as an office, as well as aim to efficiently take out a required document as required. In recent years, the systems have been developed and become widely available. Such an electronic document management system includes at least an image scanner which scans image information of a paper document; a document management server which stores the scanned information in a storage device such as a hard disk in the form of an electronic document as well as retrieves the stored electronic document; and a terminal which displays an image of the scanned paper document or the retrieved electronic document. In order to store an electronic document, document attribute information is typically attached to the electronic document so that the electronic document is easily retrieved afterward. For example, a document attribute extraction sheet containing a plurality of document attribute information items including a document name, a creation date, a creator name, and a keyword, is simultaneously scanned as a cover sheet of the paper document. The document attribute information contained in the document attribute extraction sheet is thus obtained, and the obtained document attribute information is attached to the electronic document.

### SUMMARY OF THE INVENTION

However, if an error occurs even for a single document attribute information item during the image scanning of the document attribute extraction sheet, incorrect document attribute information is attached to the electronic document. In order to avoid this kind of problem, Japanese Laid-Open Patent Application No. 2005-122324 suggests the following method: Document attribute information is entered into the document management server in advance. There is also prepared an identification document containing an identifier associated with the document attribute information, printed thereon. By image scanning a paper document as well as the identification document using the scanner, the document attribute information is reliably attached to the electronic document.

However, there is still plenty of room for improvement in the conventional technology for sorting out and storing paper documents. When paper documents are to be sorted out and stored, their identification documents are required. When a new sorting is attempted, new identification documents need to be printed.

Based on the assumption that a plurality of users register an electronic document, there has to be no overlap between the names of the electronic documents registered by the users.

Along with the acceleration of electronic document distribution caused by the enactment of the e-Document Law and others, it is now more important than ever that the originality of paper documents is kept intact when transforming them to electronic documents. In order to achieve this, an electronic signature and a time stamp are preferably available to an electronic document. It is also preferable that a password for access control is available to an electronic document to ensure its security when the document is registered. In this case, in order to prevent a user other than a creator from abusing the creator's digital certificate as well as to prevent an electronic document from being falsified, it is preferable that an electronic signature is automatically affixed to an electronic document after scanning.

In order to put paper documents in a file folder, the documents are generally sorted out by making an index for the documents based on category names. Therefore, in order to register electronic documents, it is preferable that a similar approach is employed to sort out the documents.

The present invention is conceived in light of the foregoing drawbacks, and it is an object of the present invention to provide an electronic document management system capable of sorting out and storing electronic documents automatically, in a method desired by a user, without the necessity of using any identification document. It is another object of the present invention to provide an electronic document management system capable of attaching an electronic signature, a time stamp, a password or the like to an electronic document automatically and securely. It is yet another object of the present invention to provide an electronic document management system capable of registering electronic documents automatically in an approach similar to the conventional filing method which employs file folders.

In order to achieve the aforementioned objects, according to the present invention, there is provided an electronic document management system comprised of: an image scanner which optically scans a paper document so as to produce an electronic document based on the scanned paper document; and an electronic document management server which manages the produced electronic document, wherein: the electronic document management server includes: a storage unit which stores document management information indicating a method for managing the electronic document, in such a manner that the document management information is associated with a management name which is a name of the document management information; a first transmitting unit which transmits the management name stored in the storage unit to the image scanner; a first receiving unit which receives the electronic document together with the management name from the image scanner; and a processing unit which processes the electronic document received by the first receiving unit, in accordance with the management method associated with the management name received by the first receiving unit; and the image scanner includes: a producing unit which produces the electronic document; a second receiving unit which receives the management name from the electronic document management server; a console panel which allows a user to select a given management name from the management name received by the second receiving unit; and a second transmitting unit which transmits the electronic document produced by the producing unit as well as the management name selected with the console panel, to the electronic document management server.

According to the electronic document management system of the present invention, the management names pre-stored in the electronic document management server, associated with the document management information, are displayed on the console panel of the image scanner. When a user selects a given management name, an electronic document is processed in accordance with the management method associated with the selected management name. This allows electronic documents to be sorted out and stored automatically in accordance with the management method desired by a user, without the necessity of using any identification document.

The present invention is not limited to the above electronic document management system. The present invention is also applicable to an electronic document management server included in the electronic document management system; to an electronic document management method including steps typifying the electronic document management system; and to a program which directs a computer to perform the steps. Such a program can be delivered through a recording medium such as a CD-ROM, or a transmission medium such as the Internet.

### FURTHER INFORMATION ABOUT TECHNICAL BACKGROUND TO THIS APPLICATION

The disclosure of Japanese Patent Application No. 2006-121478 filed on Apr. 26, 2006 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 shows a configuration of an electronic document management system according to the present invention;

FIG. 2 is a block diagram showing an electronic document terminal 3;

FIG. 3 shows a login screen displayed on a display unit 17 of the electronic document terminal 3;

FIG. 4 shows a document registration screen displayed on the display unit 17 of the electronic document terminal 3;

FIG. 5 is a block diagram showing a document management information registration processing unit of an electronic document management server 2;

FIG. 6A and FIG. 6B show a messages and a response between the electronic document terminal 3 and the electronic document management server 2, respectively;

FIG. 7 shows a folder and file structure of the electronic document management server 2;

FIG. 8 shows a data structure of a document management database 62 shown in the folder structure of FIG. 7;

FIG. 9 is a flow chart showing a document management information registration process performed in the electronic document terminal 3 and the electronic document management server 2;

FIG. 10 is a block diagram showing an image scanner 4;

FIG. 11 shows an appearance of a console panel of the image scanner 4;

FIGS. 12A, 12B, 12C, and 12D show a message or a response between the image scanner 4 and the electronic document management server 2;

FIG. 13 shows a data structure of a certificate management database 48 of the electronic document management server 2;

FIG. 14 is a block diagram showing a document registration processing unit of the electronic document management server 2;

FIG. 15 is a flow chart showing the first half of the document registration process performed in the image scanner 4 and the electronic document management server 2;

FIG. 16 is a flow chart showing the latter half of the document registration process performed in the image scanner 4 and the electronic document management server 2;

FIG. 17 shows a document registration screen displayed on the display unit 17 of the electronic document terminal 3;

FIG. 18 shows another data structure of the document management database 62;

FIG. 19 shows an appearance of a console panel unit 90 of the image scanner 4;

FIG. 20 shows another document registration screen displayed on the display unit 17 of the electronic document terminal 3;

FIG. 21 shows yet another data structure of the document management database 62;

FIG. 22 shows another appearance of the console panel unit 90 of the image scanner 4;

FIG. 23 shows yet another appearance of the console panel unit 90 of the image scanner 4;

FIG. 24 shows further another appearance of the console panel unit 90 of the image scanner 4;

FIG. 25 shows yet another document registration screen displayed on the display unit 17 of the electronic document terminal 3;

FIG. 26 shows further another document registration screen displayed on the display unit 17 of the electronic document terminal 3;

FIG. 27 shows still another document registration screen displayed on the display unit 17 of the electronic document terminal 3;

FIG. 28 shows a paper document 420 to be scanned with the image scanner 4;

FIG. 29 shows yet another data structure of the document management database 62; and

FIG. 30 shows another folder and file structure of the electronic document management server 2.

### DESCRIPTION OF THE PREFERRED EMBODIMENT

In a first aspect of the present invention, there is provided an electronic document management system configured of: an image scanner which optically scans a paper document so as to produce an electronic document based on the scanned paper document; and an electronic document management server which manages the produced electronic document. The electronic document management server includes: a storage unit which stores document management information indicating a method for managing the electronic document, in such a manner that the document management information is associated with a management name which is a name of the document management information; a first transmitting unit which transmits the management name stored in the storage unit to the image scanner; a first receiving unit which receives the electronic document together with the management name from the image scanner; and a processing unit which processes the electronic document received by the first receiving unit, in accordance with the management method associated with the management name received by the first receiving unit. The image scanner includes: a producing unit which produces the electronic document; a second receiving unit which receives the management name from the electronic document management server; a console panel which allows a user to select a given management name from the management name(s) received by the second receiving unit; and a second transmitting unit which transmits the electronic document produced by the producing unit as well as the management name selected with the console panel, to the electronic document management server.

According to this configuration, the management name pre-stored in the electronic document management server, associated with the document management information, is displayed on the console panel of the image scanner. When a user selects a given management name, an electronic document is processed in accordance with the management method associated with the selected management name.

This allows electronic documents to be sorted out and stored automatically in accordance with the management method desired by a user, without the necessity of using any identification document.

In a second aspect of the invention, an electronic document management system is provided the same as in the first aspect. In this aspect, the image scanner further includes an acquiring unit which acquires identification information for identifying the user. The second transmitting unit transmits the identification information to the electronic document management server. The storage unit stores the identification information in such a manner that the identification information is associated with the document management information. The first transmitting unit transmits only the management name associated with the identification information, to the image scanner.

According to the configuration, only the management name associated with the identification information is displayed on the console panel. Therefore, there is no overlap between the file names registered by a plurality of users. In addition, the management name associated with the identification information belonging to an outsider is not displayed on the console panel so that the management name to be selected is quickly found.

In a third aspect of the invention, an electronic document management system is provided the same as in the second aspect. In this aspect, the acquiring unit includes a memory reader which reads the identification information stored in an external memory of the electronic document management system.

According to this configuration, the memory reader can read identification information. Therefore, a user does not have to manually enter an identification number having a plurality of digits, as identification information, thereby saving the user the manual operation. If a contactless memory reader is employed so as to read information from the memory, a user is identified with a simpler operation (substantially no operation).

In a fourth aspect of the invention, an electronic document management system is provided the same as in the first aspect. In this aspect, the console panel does not accept manually entered information as the identification information.

According to this configuration, the information manually entered with the console panel is not regarded as the identification information so that a user is authenticated by a method capable of effectively preventing spoofing.

In a fifth aspect of the invention, an electronic document management system is provided the same as in the second aspect. In this aspect, the electronic document management server further includes a memory unit which stores a digital certificate unique to each piece of the identification information. The storage unit stores, as part of the document management information, signature requirement information which indicates whether or not an electronic signature is required to be affixed to the electronic document. The processing unit affixes an electronic signature to the electronic document based on the digital certificate associated with the identification information in the case where the signature requirement information indicates that the electronic signature is required to be affixed.

This configuration allows an electronic signature to be automatically affixed to an electronic document so as to ensure the absence of electronic document falsification without any trouble when storing a paper document in electronic form. If the configuration is employed such that a given user's digital certificate is accessed through the user's card ID or biometric data, the configuration securely prevents the digital certificate from being used by an outsider. In addition, an electronic signature is affixed to an electronic document automatically. This prevents the data falsification on an electronic document obtained by scanning although data falsification causes great concern about electronic document distribution.

In a sixth aspect of the present invention, an electronic document management system is provided the same as in the second aspect. In this aspect, the storage unit stores folder name information which indicates the destination of the electronic document, as part of the document management information. The processing unit stores the electronic document in the folder having a name containing the identification information and the folder name information.

According to this configuration, a folder name is created by adding identification information to a pre-specified folder name. The configuration prevents the overlap between folder names, and allows electronic documents to be retrieved easily.

In a seventh aspect of the invention, an electronic document management system is provided the same as in the first aspect. In this aspect, the storage unit stores, as part of the document management information, file name information which indicates the file name of the electronic document, and extension requirement information which indicates whether or not the file name of the electronic document is required to be extended. The processing unit creates a file name by adding either serial number information or date/time information to the file name information in the case where the extension requirement information indicates that the file name is required to be extended.

According to this configuration, the unique information produced by the document management server (serial number or date/time information) is added to a pre-specified file name, thereby creating a file name. The configuration prevents the overlap between file names, and allows electronic documents to be retrieved easily.

In an eighth aspect of the invention, an electronic document management system is provided the same as in the first aspect. In this aspect, the storage unit stores, as part of the document management information, a password for controlling access to the electronic document, and password requirement information which indicates whether or not the password is required to be assigned to the electronic document. The processing unit sets the password stored in the storage unit for the electronic document in the case where the password requirement information indicates that the password is required to be assigned.

This configuration automatically assigns a password to an electronic document so as to set access control to the electronic document without any trouble when its original paper document is stored. In the case of printing a registration screen, if a configuration is employed such that password information is not displayed, the password is protected.

In a ninth aspect of the invention, an electronic document management system is provided the same as in the first aspect. In this aspect, the storage unit stores, as part of the document management information, time stamp requirement information which indicates whether or not a time stamp is required to be attached to the electronic document. If the time stamp requirement information indicates that the time stamp is required to be attached, the processing unit accesses a time-stamping authority so as to obtain a time-stamp token, and attaches the obtained time-stamp token to the electronic document.

This configuration automatically attaches a time-stamp token to an electronic document so as to prove the existence of the electronic document without any trouble when its original paper document is stored.

In a tenth aspect of the invention, an electronic document management system is provided the same as in the first aspect. In this aspect, the first transmitting unit transmits an item editable by the user to the image scanner, out of the item(s) contained in the document management information. The console panel shows the editable item to the user. When the user edits the item, the console panel accepts the edited item. The second transmitting unit transmits the edited item to the electronic document management server. The processing unit performs a process in accordance with the management method indicated by the edited item.

This configuration allows a user to edit an item contained in the document management information using the image scanner, so that a password or the like can be edited immediately before an electronic document is registered. Since the edited password does not affect a document management database, the password is available only for a single use.

In an eleventh aspect of the invention, an electronic document management system is provided the same as in the first aspect. In this aspect, the first transmitting unit transmits an item editable by the user to the image scanner, out of the item(s) contained in the document management information. The console panel shows the editable item to the user. When the user edits the item, the console panel accepts the edited item. The second transmitting unit transmits the edited item to the electronic document management server. The storage unit stores the edited item as part of the document management information.

This configuration allows a user to edit an item contained in the document management information using the image scanner, so that a password or the like can be edited immediately before an electronic document is registered. Since the edited password affects a document management database, the password is assigned to an electronic document with no change subsequently.

In a twelfth aspect of the invention, an electronic document management system is provided the same as in the first aspect. In this aspect, the electronic document management server further includes an image recognition unit which recognizes an image in the electronic document. The processing unit performs a process in accordance with a result of the image recognition.

According to this configuration, the information obtained by the recognition using the image recognition unit is employed as part of predetermined document management information. For example, an image recognition process such as OCR is performed on the digital image data of the paper document, read by the image scanner, so as to extract the title of the document. The document title thus extracted then becomes a document folder name so that the produced electronic document is stored in the folder with that document folder name. According to this configuration, a user stores an electronic document file in an optimum document folder, instead of storing the file in a pre-specified document folder or without pre-specifying a document folder.

In a thirteenth aspect of the invention, an electronic document management system is provided the same as in the first aspect. In this aspect, the electronic document management server further includes an image recognition unit which recognizes an image in the electronic document. The storage unit stores a result of the image recognition as part of the document management information.

According to this configuration, a document management database is updated in such a manner that the information obtained by the recognition using the image recognition unit is regarded as part of predetermined document management information. This aspect is similar to the twelfth aspect in that an electronic document file is stored in an optimum document folder. In this aspect, the document management database is updated so that the electronic document file is stored in an optimum document folder thereafter.

In a fourteenth aspect of the invention, an electronic document management system is provided the same as in the first aspect. In this aspect, the electronic document management system is further configured of an electronic document terminal which includes: a third receiving unit which receives, from the electronic document management server, a registration form as a template for registering the document management information; a display unit which displays the registration form received by the third receiving unit; an input unit which enters the document management information in the registration form displayed on the display unit; and a third transmitting unit which transmits the registration form to the document management server, the registration form in which the document management information is entered by the input unit.

According to this configuration, since document management information can be entered in the registration form, using the electronic document terminal, it becomes easier to enter document management information.

In a fifteenth aspect of the invention, an electronic document management system is provided the same as in the fourteenth aspect. In this aspect, the third receiving unit receives the registration form which has been pre-registered. The display unit displays the registration form which has been pre-registered. The input unit edits the contents of the registration form which has been pre-registered.

According to this configuration, when new document management information is registered, the information based on the pre-registered document management information is transmitted to the electronic document terminal so that a user can edit the information using the electronic document terminal. Specifically, the electronic document terminal displays the document registration form in which its document management information has been registered, so that a user can edit the contents of the document management information displayed on the document registration form. This allows the edited information on the document registration form, to be registered in the electronic document management server as new document management information. In other words, a user makes full use of the existing document management information when registering new document management information, therefore, a user does not have to enter again all the item values required for registration, thereby saving the user the trouble of entering register information.

In a sixteenth aspect of the invention, an electronic document management system is provided the same as in the fourteenth aspect. In this aspect, the input unit allows the image scanner to edit an item selected from the item(s) contained in the document management information.

According to this configuration, an item, which is selected from the item(s) included in the document management information, is edited using the image scanner, thereby offering convenience to the user.

### Embodiment

Hereinafter, an embodiment of the present invention will be described with reference to the accompanying drawings.

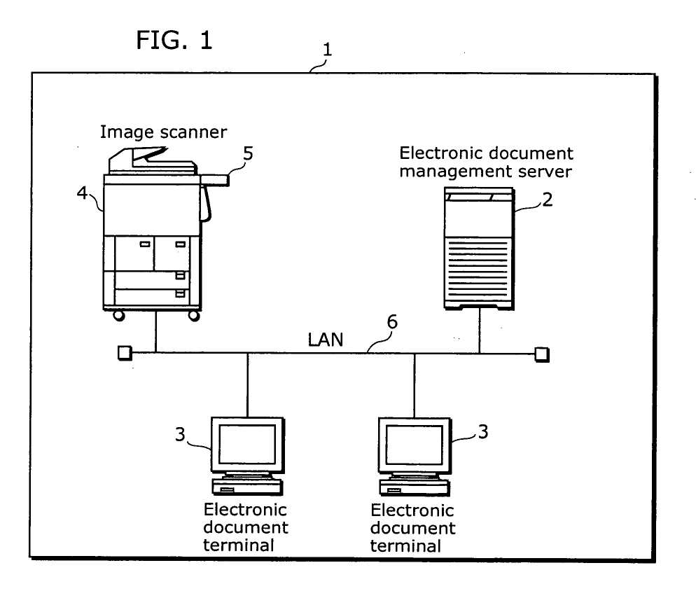

FIG. 1 shows a configuration of an electronic document management system of the present invention.

Referring to FIG. 1, an electronic document management system 1 includes an electronic document terminal 3 and an image scanner 4 operated by a user; and an electronic document management server 2. They are connected through a local area network (LAN) 6.

In order to newly register document management information, a user enters document management information from the electronic document terminal 3 so as to register the information in the electronic document management server 2. The user carries an integrated circuit (IC) card with a memory which stores identification (ID) information therein (also referred to as a “card ID”). The user holds the IC card over an IC card reader 5 as a memory reader so as to be authenticated by the image scanner 4. The user then selects a document registration form containing items required for document management information registration. In response to this, the image scanner 4 displays, on a touch screen of its console panel, the list of the document management information names which the user has registered. The user sets a paper document on the image scanner 4, selects one document management information name on the console panel of the image scanner 4, and then touches the start button. In response to this, the image scanner 4 converts the paper document into electronic form so as to transmits the converted electronic document, the selected document management information name, and the authenticated card ID, to the electronic document management server 2.

The electronic document management server 2 performs a series of processes specified by the received card ID and document management information name, on the received electronic document. Subsequently, the electronic document is stored in a predetermined document folder in a directory tree.

As has been mentioned above, the electronic document management system 1 relates to the following two processes: a document management information registration process performed by the electronic document terminal 3 and the electronic document management server 2; and a document registration process performed by the image scanner 4 and the electronic document management server 2.

First, the document management information registration process is illustrated by an example, followed by an example of the document registration process.

(Example of Management Information Registration Process)

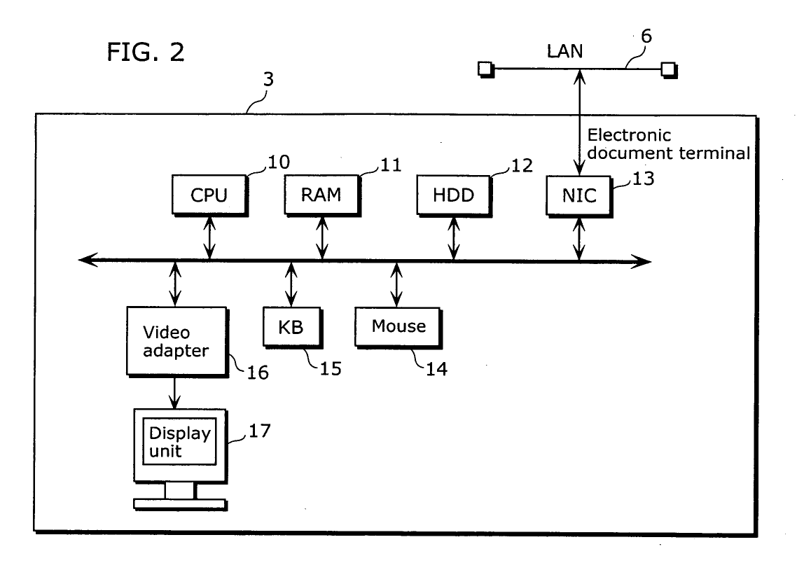

FIG. 2 is a block diagram showing the electronic document terminal 3 in the electronic document management system 1.

Referring to FIG. 2, the electronic document terminal 3 includes a central processing unit (CPU) 10 which executes a program; a random access memory (RAM) 11 which works as a main memory, a work area, or the like; a hard disk drive (HDD) 12 which stores a program and data; a network interface card (NIC) 13 which makes allows a packet transmission through the LAN 6; a keyboard (KB) 15 and a mouse 14 with which a user enters data; and a video adapter 16 and a display unit 17 which display a processing result.

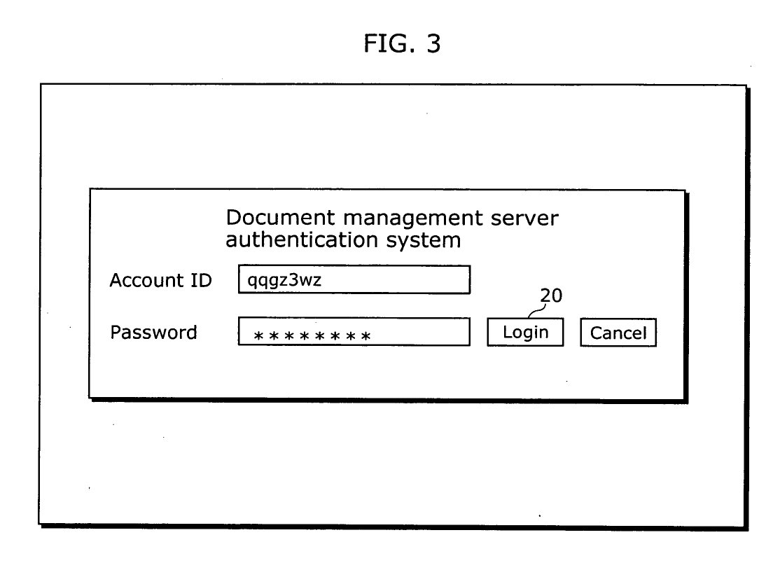

FIG. 3 shows a login screen displayed on the display unit 17 of the electronic document terminal 3. The login screen allows a user to enter his/her account ID and password so as to authenticate the user when the user logs in the electronic document management server 2.

Referring to FIG. 3, a user enters his/her own account ID (qqgz3wz) and password (********), and then touches a login button 20. The account ID and the password are transmitted to the electronic document management server 2 so as to authenticate the user, thereby allowing the user to log in the electronic document management server 2.

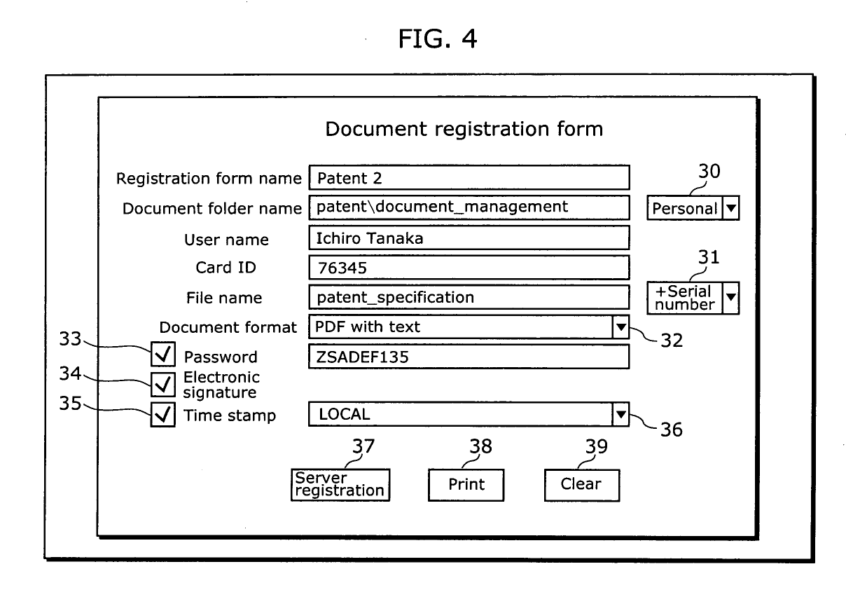

FIG. 4 shows a document registration screen displayed on the display unit 17 of the electronic document terminal 3. The document registration screen appears when the document registration form registered in the electronic document management server 2 is opened after logging in the electronic document management server 2. As the document registration form of the embodiment, a Portable Document Format (PDF) file is employed. Hypertext Markup Language (HTML) and Excel (Microsoft registered trade mark) forms are also available.

The document registration screen shown in FIG. 4 includes a text box, a combo box, and a check box, which are provided to enter data therein, called form fields. The document registration screen also includes a button for executing a predetermined process.

Hereinafter, a description is given for document management information registration.

In the field “Registration Form Name”, the name of a document registration form (PATENT 2) is entered. The name is displayed on the console panel of the image scanner 4 as a document management information name.

In the field “Document Folder Name”, the destination folder name of the electronic document to be stored (patent\document_management) is entered. In this case, the mark ‘\’ in the folder name denotes a delimiter which shows the path of a file in a directory tree. In a combo box 30, either “PERSONAL” for creating the folder in a personal folder or “SHARED” for creating the folder in a shared folder, is selected.

In the field “User Name”, the name of a user (Ichiro Tanaka) is entered. In the field “Card ID”, the ID of an IC card for authentication used by the user in the image scanner 4 (76345) is entered.

In the field “File Name”, the name of a file to store the electronic document (patent_specification) is entered. In a combo box 31, any one of “NONE”, “+SERIAL NUMBER”, or “+DATE AND TIME” is selected. If “+SERIAL NUMBER” is selected as the file name of the electronic document to be stored in the electronic document management server 2, a file name is created by concatenating the entered file name with a unique number produced by the electronic document management server 2. If “+DATE AND TIME” is selected as the file name of the electronic document to store the electronic document management server 2, a file name is created by concatenating the entered file name with the date and time when the file name is created.

In a combo box 32, either “PDF” or “PDF WITH TEXT” is selected as the target electronic document format. The format “PDF WITH TEXT” is available by layout-analyzing an image of the paper document, recognizing the characters, and overlaying transparent text characters on the image characters of the target PDF document. In the format “PDF WITH TEXT”, therefore, it is possible to retrieve any character thereon.

If a checkmark is placed in a check box 33, access control is set on the target PDF document using the entered password (ZSADEF135).

If a checkmark is placed in a check box 34, an electronic signature is affixed to the target PDF document.

If a checkmark is placed in a check box 35, a time-stamp token is acquired from the time-stamping authority (LOCAL) selected in a combo box 36 so that the token is attached to the target PDF document.

There is provided a server registration button 37 so as to transmit the form field values entered in the above boxes, to the electronic document management server 2. When the server registration button 37 is touched, the Java® script which describes the process to be performed by the button operation is executed. The form field names with their values as well as the processing script name on the side of the electronic document management server 2 are transmitted to the electronic document management server 2 as a document management information registration message. In this case, the term “processing script name” means the name of a script which can command processing. The term “processing script” (also referred to as simply “script”) denotes, for example, data concerning the processing procedure to be followed by the electronic document management server 2 such as document management information registration.

There is provided a print button 38 so as to print out the registration screen. When the print button 38 is touched, the Java Script® which describes the process be performed by the button operation is executed in order to print out the registration screen. The entered password information is deleted so as not to be printed out, and obscured or replaced by another notation. This prevents the password from being exposed to an outsider.

There is provided a clear button 39 so as to clear the values of the form fields and reset the registration screen to its initial state.

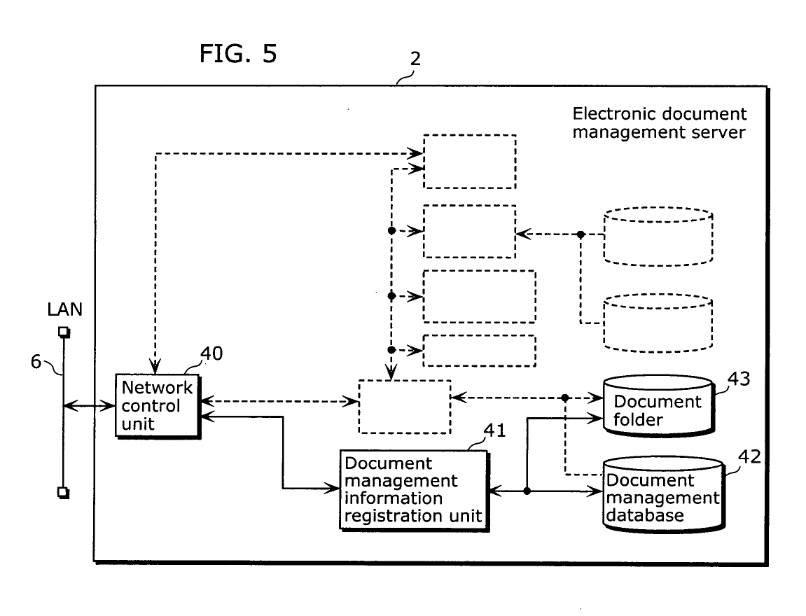

FIG. 5 is a block diagram showing a document management information registration processing unit of the electronic document management server 2. In FIG. 5, the area enclosed within the solid line relates to the document management information registration process.

Referring to FIG. 5, in the electronic document management server 2, the following elements relate to the document management information registration process: a network control unit 40, a document management information registration unit 41, a document management database 42, and a document folder 43. The network control unit 40 processes a communication protocol, and fetches/transmits a message or a response. The document management information registration unit 41 processes the document management information registration message received from the electronic document terminal 3, and registers document management information in the document management database 42. The document management database 42 is shown as an example of the storage unit according to the present invention.

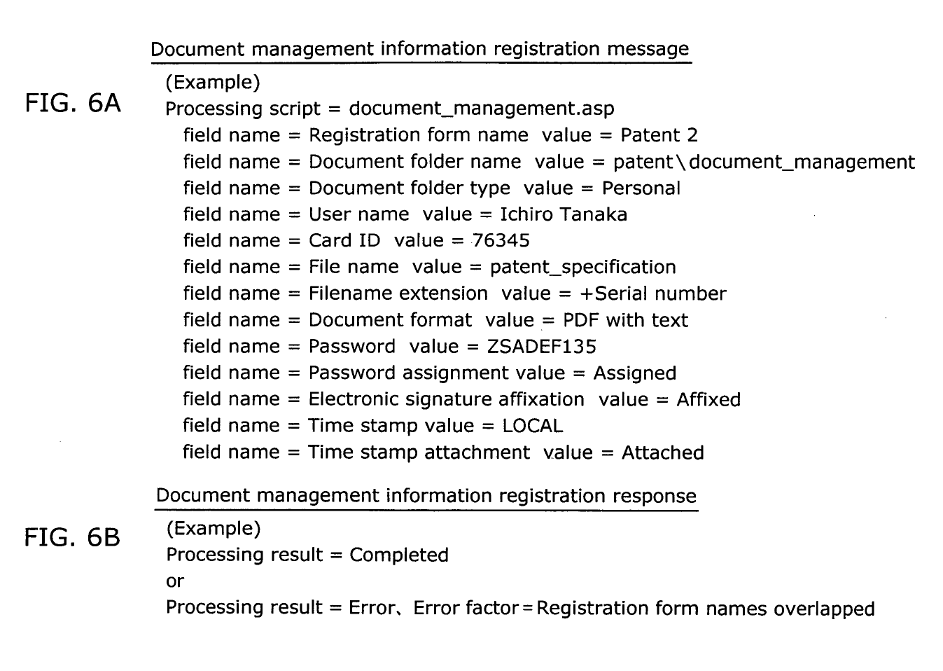

FIG. 6A and FIG. 6B show a message and a response between the electronic document terminal 3 and the electronic document management server 2, respectively. When the server registration button 37 is touched on the document registration screen shown in FIG. 4, a document management information registration message is transmitted to the electronic document management server 2.

Referring to FIG. 6A, a document management information registration message includes a processing script for processing the registration of document management information, and a form field name with its value. Referring now to FIG. 6B, a document management information registration response is transmitted from the electronic document management server 2 in response to the registration process. If the document management database 42 has identical card ID (76345) and registration form name (Patent 2) registered therein, the response “REGISTRATION FORM NAMES OVERLAPPED” is transmitted to the electronic document terminal 3.

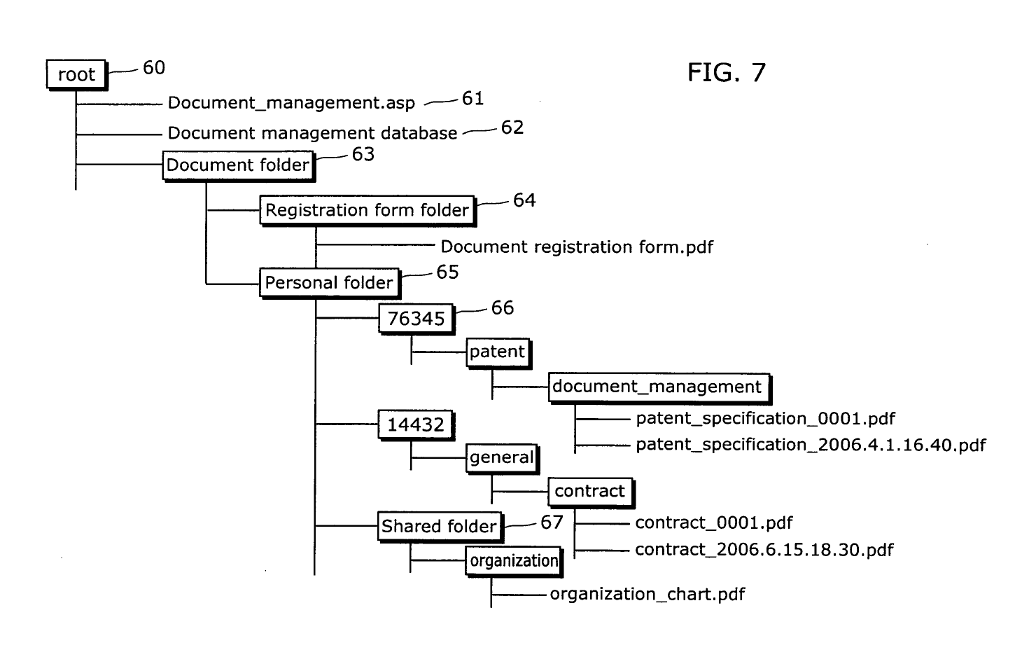

FIG. 7 shows a folder and file structure of the electronic document management server 2.

Referring to FIG. 7, under a root directory 60 are arranged a script “document_management.asp” 61 for processing document management information registration; a document management database 62 corresponding to the document management database 42 shown in FIG. 5; and a document folder 63 corresponding to the document folder 43 shown in FIG. 5. Under the document folder 63, a registration form folder 64 which contains “document_registration_form.pdf” displayed on the document registration screen shown in FIG. 4; and a personal folder 65. Under the personal folder 65, a document folder 66 for the user having the card ID (76345) as his/her folder name; and a shared document folder 67. Under the user document folder 65 or the shared document folder 67, a path and a folder are created for the document folder name (patent\document_management) entered from the document registration screen shown in FIG. 4.

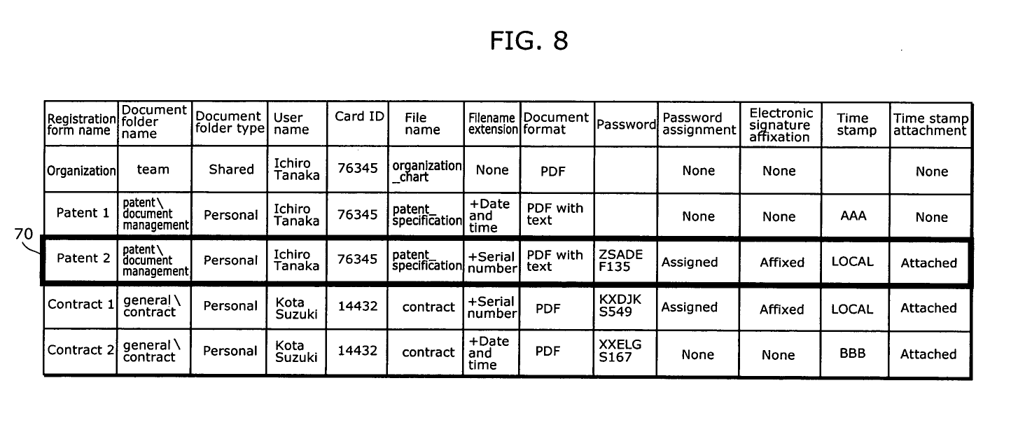

FIG. 8 shows a data structure of the document management database 62.

Referring to FIG. 8, five types of document management information is recorded in rows. The respective field values of the document management information entered from the document registration screen, are recorded in columns. Let us take an example of a row 70 as the document management information registered from the document registration screen shown in FIG. 4. The document management database 62 contains the following values of the document management information recorded therein: “PATENT 2” in the field “Registration Form Name; “patent\document management” in the field “Document Folder Name”; “PERSONAL” in the field “Document Folder Type; “Ichiro Tanaka” in the field “User Name”; “76345” in the field “Card ID”; “patent_specification” in the field “File Name”; “+SERIAL NUMBER” in the field “Filename Extension”; “PDF WITH TEXT” in the field “Document Format”; “ZSADEF135” in the field “Password”; “ASSIGNED” in the field “Password Assignment”; “AFFIXED” in the field “Electronic Signature Affixation”; “LOCAL” in the field “Time-Stamping Authority”; and “ATTACHED” in the field “Time-Stamping Attachment”. The field “Registration Form Name” is also referred to as “Document Management Information Name” or “Management Name”.

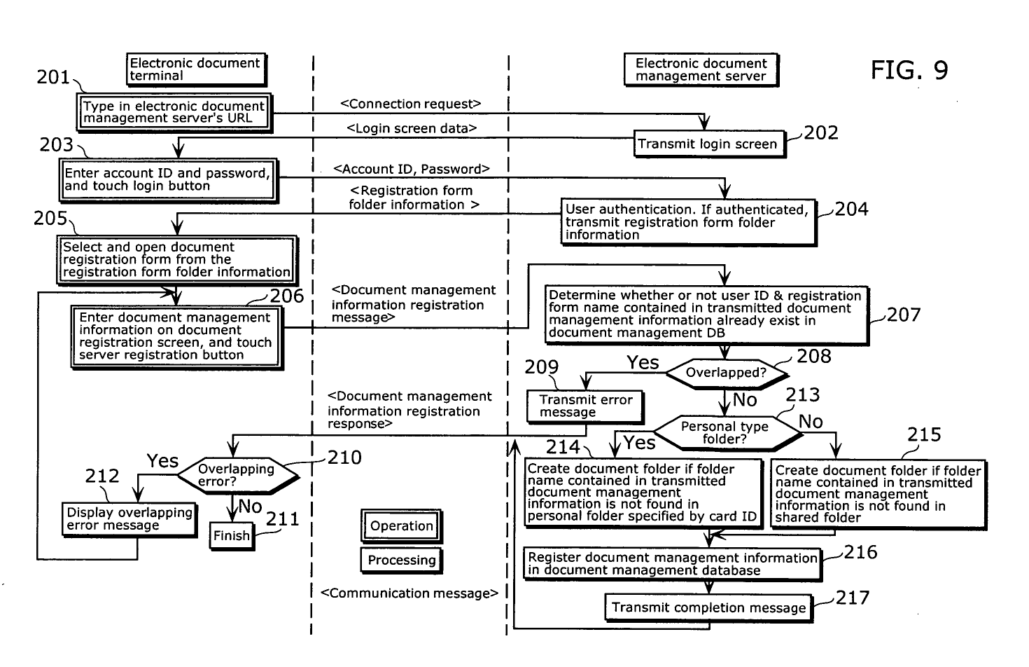

FIG. 9 is a flow chart showing a document management information registration process. Hereinafter, a description is given for the document management information registration process with reference to the flow chart of FIG. 9.

In order to request a connection to the electronic document management server 2, a user types in the Uniform Resource Locator (URL) of the electronic document management server 2 on a Web browser screen of the electronic document terminal 3 (Step 201).

The electronic document management server 2 receives the connection request, and then transmits login screen data to the electronic document terminal 3 (Step 202). The electronic document terminal 3, for example, displays the authentication screen shown in FIG. 3. When the user enters his/her valid account ID and password, and then touches the login button 20 (Step 203), the account ID and password are transmitted to the electronic document management server 2. The electronic document management server 2 allows the user to log in, and then transmits document registration form folder information to the electronic document terminal 3 (Step 204). The names of document registration form files are listed by the electronic document terminal 3. When the user selects and opens one of the document registration form files (Step 205), the document registration screen shown in FIG. 4 is displayed. After entering data to each form field, when the user touches the server registration button 37 (Step 206), the document management information registration message shown in FIG. 6A is transmitted to the electronic document management server 2.

When receiving the document management information registration message shown in FIG. 6A, the electronic document management server 2 starts a specified processing script (document_management.asp) so as to start a document management information registration process. The electronic document management server 2 determines whether or not the document management database 62 contains the document management information having the card ID and registration form name identical to those contained in the transmitted document management information registration message (Step 207). If the document management database 62 contains such document management information, the error message “REGISTRATION FORM NAMES OVERLAPPED” is transmitted to the electronic document terminal 3 as the document management information registration response shown in FIG. 6B (Step 209). When receiving the error message, the electronic document terminal 3 displays the error message “REGISTRATION FORM NAMES OVERLAPPED” so as to prompt the user to modify the entered contents (Step 212). On the other hand, if the document management database 62 does not contain such document management information, the document folder type in the document management information registration messages is examined (Step 213). If the document folder type is “PERSONAL”, the folder having the name identical to the card ID (76345) in the document management information registration message is retrieved under the personal folder 65 shown in FIG. 7. Under the folder having the identical name, a path and folder (patent\document_management) for the document folder name in the document management information registration message are created (Step 214). On the other hand, if the document folder type is “SHARED”, a path and folder are created in the same manner under the shared folder 67 show in FIG. 7 (Step 215). After the path and folder are created, the information concerning the document management information registration message is registered in the document management database 62, as document management information (Step 216). When the registration process is completed, a completion message is transmitted to the electronic document terminal 3 as a document management information registration response (Step 217).

When new document management information is registered, the electronic document terminal 3 may display the document registration form containing document management information pre-registered in the electronic document management server 2 in the first place. This allows the user to edit the contents of the document management information displayed on the document registration form, and then to register the edited information in the document registration form in the electronic document management server 2 as new document management information. Specifically, the user can take advantage of the existing document management information when registering new document management information. When new document management information is registered, it is unnecessary to enter all the required field values again from the beginning, thereby saving the user the trouble of entering register information.

The electronic document terminal 3 may register the edited document registration form in the electronic document management server 2 as a new document registration form. Specifically, the electronic document terminal 3, capable of creating a PDF file, creates a PDF file containing the contents of the edited document management information (does not necessarily have to be edited), and then transmits the PDF file to the document management server 2. At the same time, the electronic document management server 2 receives the PDF file transmitted from the electronic document terminal 3, and then registers the file as a new document registration form. This allows a document registration form to be created also in the electronic document terminal 3, thereby saving the trouble of preparing a document registration form in the electronic document management server 2.

If the new document registration form has the name identical to the name of the existing document registration form, the existing document registration form may be replaced with the new document registration form. This allows the electronic document management system to update the document registration form also in the electronic document terminal 3.

After the electronic document terminal 3 displays the pre-registered, existing document registration form, when receiving the information edited in the electronic document terminal 3 therefrom (does not necessarily have to be edited), the electronic document management server 2 may create a PDF file containing the contents of the edited document management information so as to register the PDF file in the registration form folder as a new document registration form. This allows the document management system to add a new document registration form thereto, containing the contents of the document management information edited in the electronic document terminal 3 even if the electronic document terminal 3 is incapable of creating a PDF file.

(Example of Document Registration Process)

Next, the document registration process is illustrated by an example.

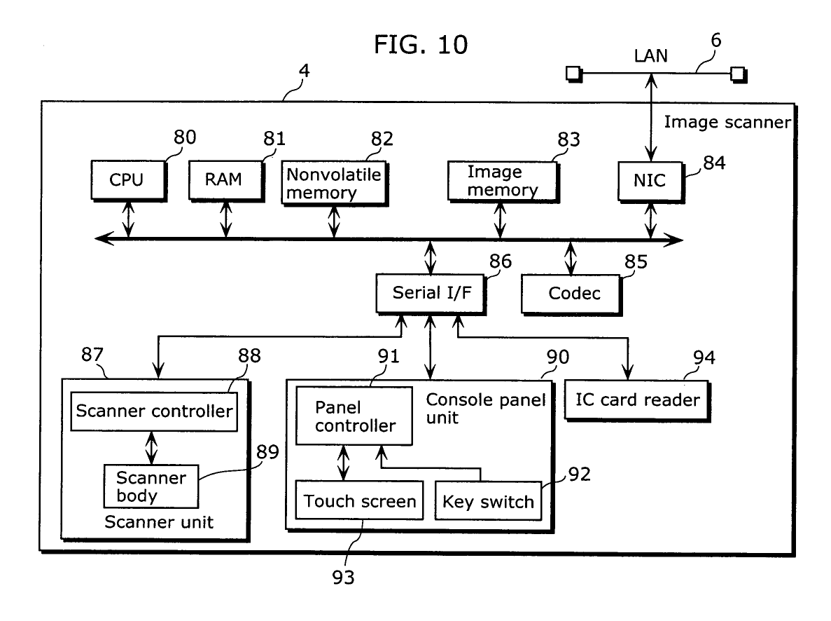

FIG. 10 is a block diagram showing the image scanner 4 in the electronic document management system 1 shown in FIG. 1.

Referring to FIG. 10, the image scanner 4 includes a CPU 80 which executes a program; a RAM 81 which works as a main memory, a work area, or the like; a nonvolatile memory 82 which stores a program and data; an image memory 83 which stores image information; a NIC 84 which allows a packet transmission through the LAN 6; a codec 85 which compresses image information data; a serial interface (I/F) 86 which allows a serial communication between the CPU 80 and input/output devices; a scanner unit 87 having a scanner body 89 and a scanner controller 88; a console panel unit 90 which has a touch screen 93 with a display panel and a touch sensor, a key switch 92, and a panel controller 91 for controlling these devices; and a contactless IC card reader 94.

The scanner body 89 with the scanner controller 88 is shown as an example of the producing unit according to the present invention. The NIC 84 is shown as an example of the second receiving/transmitting unit according to the present invention. The console panel unit 90 is shown as an example of the console panel according to the present invention. The contactless IC card reader 94 is shown as an example of the acquiring unit according to the present invention.

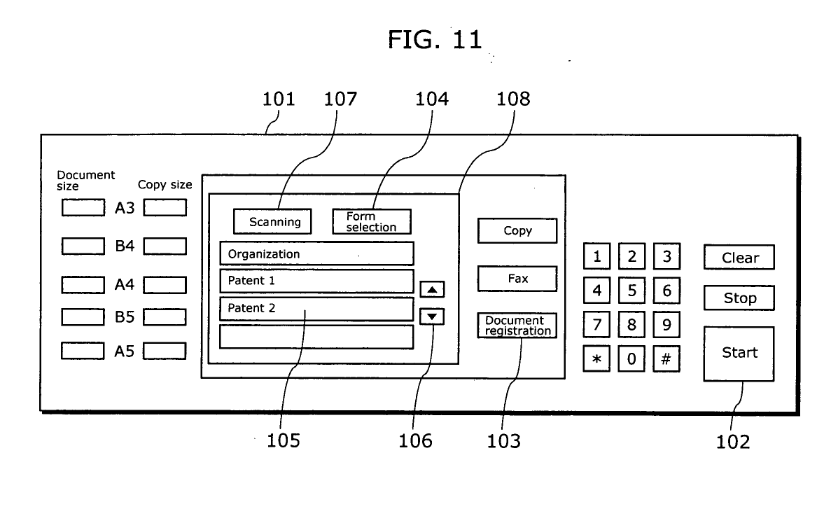

FIG. 11 shows an appearance of the console panel unit 90 of the image scanner 4.

There is provided a console panel 101 which includes a touch screen 93 and a key switch 92. In FIG. 11, a start button 102 and a document registration button 103 are shown as examples of the key switch 92. There is also provided a touch panel 108 on which a scanning button 107, a form selection button 104, and a document registration form name 105 are displayed. There is provided a scroll button 106 so as to scroll the list of the document registration form names 105.

The console panel 101 displays the key switches on the touch screen so as to work as the so-called “soft keyboard”. With this soft keyboard function, a user can input a given key code by touching the corresponding onscreen key. The function allows a user to input characters other than numeric, such as alphabetical characters, marks, kana characters, and Chinese characters, and to input specified information such as “OK”, “cancel”, and “print”.

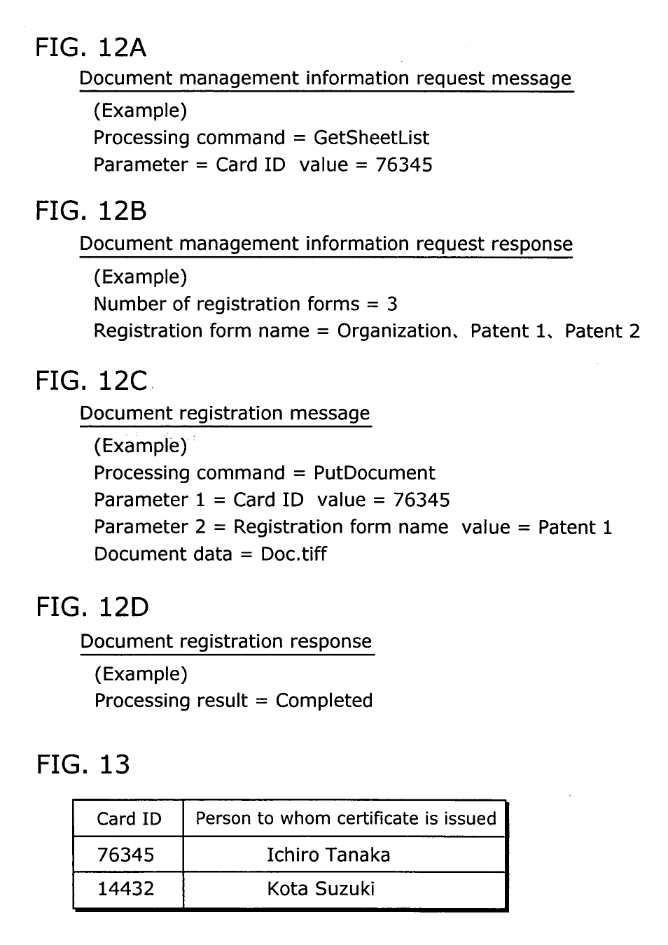

FIGS. 12A, 12B, 12C, and 12D show a message or a response between the image scanner 4 and the electronic document management server 2.

When the form selection button 104 and the start button 102 of the image scanner 4 are touched, a document management information request message is transmitted from the image scanner 4 to the electronic document management server 2. Referring to FIG. 12A, the document management information request message includes the following items: a processing command (GetSheetList); and an authentication card ID (76345). Referring to FIG. 12B, a document management information request response includes the items “Registration Form Name” (ORGANIZATION, PATENT 1, PATENT 2) and “Number of Registration Forms” (3) which are transmitted from the electronic document management server 2.

When the scanning button 107 and the start button 102 of the image scanner 4 are touched, a document registration message is transmitted from the image scanner 4 to the electronic document management server 2. Referring to FIG. 12C, the document registration message includes the following items: a processing command (PutDocument); an authentication card ID (76345); a registration form name (PATENT 1); and document data (Doc.tiff). Referring to FIG. 12D, a document registration response includes a completion message transmitted from the electronic document management server 2.

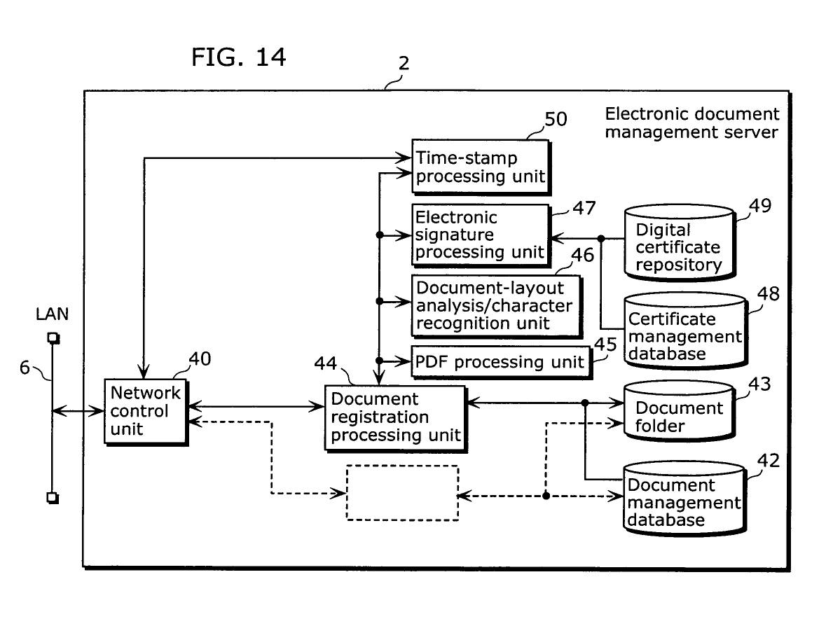

FIG. 13 shows a data structure of a certificate management database 48 (to be shown in FIG. 14). Each card ID has its corresponding name to which a digital certificate has been issued, stored in a digital certificate repository 49. Therefore, a user can access his/her digital certificate only with his/her authentication card ID.

FIG. 14 is a block diagram showing a document registration processing unit of the electronic document management server 2. In FIG. 14, the area enclosed within the solid line relates to the document registration process.

Referring to FIG. 14, in the electronic document management server 2, the following elements relate to the document registration process: a network control unit 40; a document management database 42; a document folder 43; a document registration processing unit 44; a PDF processing unit 45; a document-layout analysis/character recognition unit 46; an electronic signature processing unit 47; a certificate management database 48; a digital certificate repository 49; and a time-stamp processing unit 50. The network control unit 40 processes a communication protocol, and fetches/transmits a message or a response. The document registration processing unit 44 retrieves document management information using the card ID in a document management information request message, and then transmits the number of registration forms and a registration form name to the image scanner 4. The document registration processing unit 44 also controls the PDF processing unit 45, the document-layout analysis/character recognition unit 46, the electronic signature processing unit 47 and the time-stamp processing unit 50 based on the card ID, the registration form name, and the document data in the document registration message, so as to create an electronic document and store the electronic document in the predetermined document folder 43. The PDF processing unit 45 extracts JPEG (Joint Photographic Experts Group) data (hereinafter referred to as “JPEG data”) from a document in TIFF (Tagged Image File Format) so as to generate PDF data. The PDF processing unit 45 also sets a password for controlling the manipulation of the PDF data. The document-layout analysis/character recognition unit 46 decodes JPEG data, segments a character area from the decoded document image, and recognizes the character so as to transmit text data and text position information to the PDF processing unit 45. The electronic signature processing unit 47 retrieves, using the corresponding card ID, a name of the person to which a digital certificate has been issued and recorded in the certificate management database 48, acquires the certificate associated with the retrieved name from the digital certificate repository 49, and then affixes an electronic signature to PDF data. The time-stamp processing unit 50 accesses a specified time-stamping authority to acquire a time-stamp token, and then embeds the acquired time-stamp token in PDF data.

The network control unit 40 is shown as an example of the first transmitting/receiving unit according to the present invention. The document registration processing unit 44, the PDF processing unit 45, the document-layout analysis/character recognition unit 46, the electronic signature processing unit 47, and the time-stamp processing unit 50 are shown as examples of the processing unit according to the present invention. The certificate management database 48 and the digital certificate repository 49 are shown as examples of the memory unit according to the present invention.

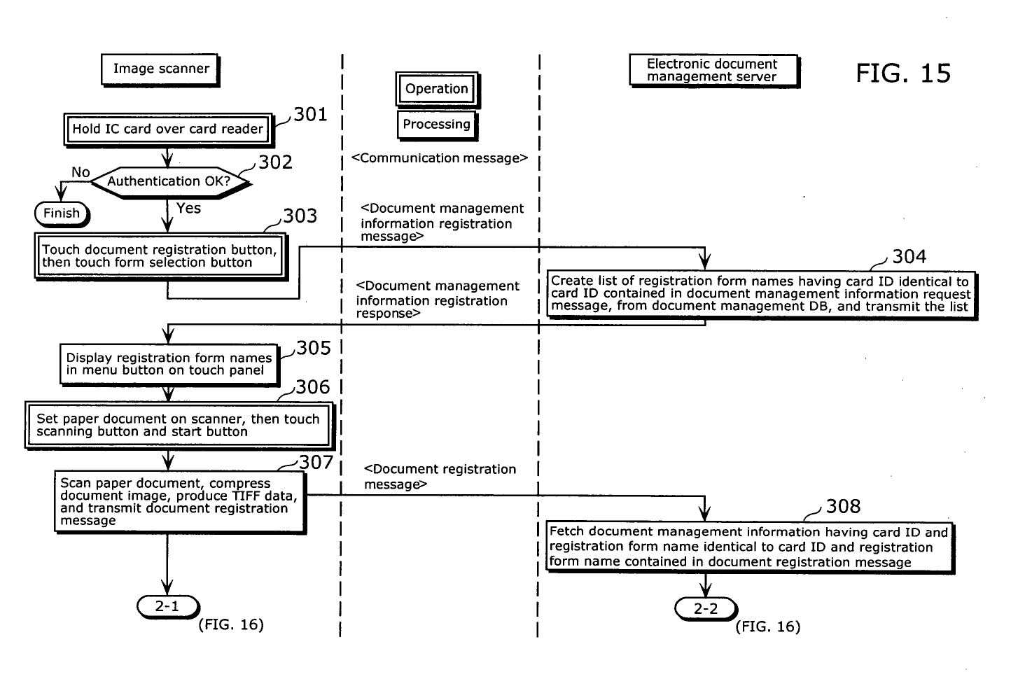

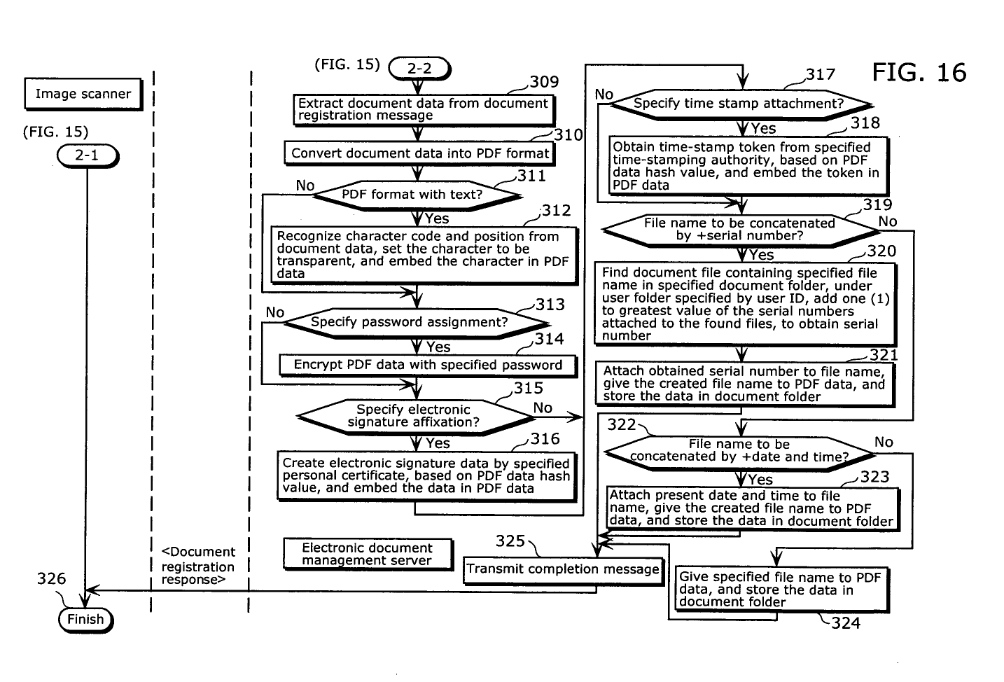

Next, a description is given for the document registration process with reference to the flow charts of FIGS. 15 and 16.

When a user holds an IC card for authentication over the IC card reader 94 (Step 301), the IC card starts its operation with power supplied by electromagnetic induction. The IC card responds to the card commands repeatedly transmitted from the IC card reader 94 by electromagnetic waves, and then transmits its card ID stored therein to the IC card reader 94.

The image scanner 4 temporarily stores the received card ID in the RAM 81. The card ID is compared to the user ID stored in the nonvolatile memory 62 (Step 302). If the nonvolatile memory 62 has a user ID identical to the card ID, the operation of the image scanner 4 is allowed. When the document registration button 103 is touched, a document registration screen is displayed on the touch panel 108. When the form selection button 104 is touched followed by touching the start button 102, the card ID stored in the RAM 81 is transmitted to the electronic document management server 2 as the parameter of the processing command (GetSheetList) for a document management information request message (Step 303).

The electronic document management server 2 retrieves, from the document management database 62, the registration form name associated with the card ID contained in the received document management information registration message, so as to transmit the number of the retrieved registration forms and the registration form names to the image scanner 4 as a document management information request response (Step 304).

The image scanner 4 displays the received registration form names on the touch panel 108 (Step 305). The user sets a paper document on the scanner body 89 of the image scanner 4, and touches the scanning button 107 and the start button 102, after selecting a registration form name 105 on the touch panel 108 (Step 306), thereby allowing the image scanner 4 to start a document registration process. The paper document is converted into digital form by the scanner unit 87 on a page-by-page basis. The digital image data is stored temporarily in the image memory 83 through the serial I/F 86. The codec 85 compresses the digital image data stored in the image memory 83 into JPEG format, and then converts the data into TIFF. The produced TIFF document data (Doc.tiff) is transmitted to the electronic document management server 2 as a document registration message, together with a processing command (PutDocument), a card ID (76345) and a registration form name (PATENT 1) (Step 307).

The document registration processing unit 44 of the electronic document management server 2 fetches the document management information containing the card ID and the registration form name identical to the card ID (76345) and the registration form name (PATENT 1) in the document registration message, from the document management database 62 (Step 308), and then transfers the document data (Doc.tiff) of the document registration message to the PDF processing unit 45 (Step 309). The PDF processing unit 45 extracts the JPEG data contained in each page of the document data (Doc.tiff) so as to produce PDF data with JPEG data as an object (Step 310).

If the document format of document management information is specified as “PDF WITH TEXT” (Step 311), the document registration processing unit 44 transfers the JPEG data to the document-layout analysis/character recognition unit 46 (Step 312). The document-layout analysis/character recognition unit 46 decodes the JPEG data, layout-analyzes the decoded document so as to segment the document into character areas for character recognition, and then transfers their character code and position to the PDF processing unit 45. The PDF processing unit 45 embeds the character code in the PDF data produced from the JPEG data, together with the character position information and the information for setting the character to be transparent.

On the other hand, if the document format is specified as “PDF”, the above process of embedding the character code is skipped. If the password assignment to the document management information is specified as “ASSIGNED” (Step 313), the document registration processing unit 44 transfers a password to the PDF processing unit 45. The PDF processing unit 45 encrypts the part of the PDF data to be obscured, with the password as a cryptographic key, so that access control is set on the PDF data using the password (Step 314).

On the other hand, if the password attachment to the document management information is specified as “NONE”, the encryption process is skipped.

If the electronic signature affixation to document management information is specified as “AFFIXED” (Step 315), the document registration processing unit 44 fetches, from the certificate management database 48, the name of the person to which a given digital certificate has been issued and which corresponds to the card ID contained in the document management information, so as to transfer the name to the electronic signature processing unit 47. The electronic signature processing unit 47 fetches the digital certificate associated with the name to which the digital certificate has been issued, from the digital certificate repository 49. The electronic signature processing unit 47 then calculates the hash value of the PDF data to which an electronic signature is to be affixed, so as to embed, in the PDF data together with a public key certificate, the signature value obtained by encrypting the hash value with the secret key of the digital certificate (Step 316).

If the time stamp attachment to document management information is specified as “ATTACHED” (Step 317), the document registration processing unit 44 transfers the PDF data to the time-stamp processing unit 50. The time-stamp processing unit 50 transmits a time-stamp token request message and the hash value calculated from the PDF data, to the time-stamping authority specified by the document management information, and embeds the time-stamp token received from the time-stamping authority in the PDF data (Step 318).

If the filename extension of document management information is specified as “+SERIAL NUMBER” (Step 319), the document registration processing unit 44 performs the process shown in Step 320. On the other hand, if not specified (Step 319), the process proceeds to Step 322.

A description is given for the process shown in Step 320. First, if “PERSONAL” is specified as a document folder type, the document registration processing unit 44 selects the folder having the name identical to the card ID under the personal folder 65 (for example, the folder 66 “76345” in FIG. 7). If “SHARED” is specified as a document folder type, the shared folder 67 is selected.

Under the folder selected above, the path and folder (for example, “patent\document_management”) specified by the document folder name is selected. Under the selected folder, the document file which has the name obtained by concatenating the file name of document management information (for example, “patent_specification”) with a serial number is further retrieved. If any relevant document file is found as a result of the retrieval, a serial number is obtained by adding one to the greatest value of the serial numbers attached to the selected document files, thereby creating a file name by concatenating the above file name with the serial number. On the other hand, if no relevant document file is found as a result of the retrieval, an initial value (for example, “0001”) is assigned as a serial number, thereby creating a file name (for example, “patent_specification_{—}0001”) by concatenating the file name with the initial value.

Next, the document registration processing unit 44 adds the filename extension “.pdf” to the file name (for example, “patent_specification_{—}0001”) so as to store PDF data in the folder (for example, “patent\document_management”) (Step 321). After the storage of the data is completed, a completion message is transmitted to the image scanner 4 as a document registration response (Step 325).

If the filename extension of document management information is specified as “+DATE AND TIME” (Step 322), the document registration processing unit 44 performs the process shown in Step 323. On the other hand, if not specified (Step 322), the process proceeds to Step 324.

A description is given for the process shown in Step 323. First, if “PERSONAL” is specified as a document folder type, the document registration processing unit 44 selects the folder having the name identical to the card ID under the personal folder 65. If “SHARED” is specified as a document folder type, the shared folder 67 is selected. Under the selected folder, the path and folder (for example, “patent\document_management”) specified by the document folder name is then selected. Next, a file name (for example, “patent_specification_{—}2006.4.1.16.40”) is created by concatenating the file name of document management information (for example, “patent_specification”) with the date and time acquired from the internal calendar and clock of the document management server 2. The filename extension “.pdf” is then added to the created file name so as to store a PDF file in the folder (for example, “patent\document_management”). After the completion of storing the file, a completion message is transmitted to the image scanner 4 as a document registration response (Step 325).

If “PERSONAL” is specified as a document folder type, the document registration processing unit 44 selects the folder having the name identical to the card ID under the personal folder 65. On the other hand, if “SHARED” is specified as a document folder type, the shared folder 67 is selected. Under the selected folder, the path and folder specified by the document folder name is selected so as to concatenate the file name of document management information with the filename extension “.pdf”, thereby storing a PDF file in the folder (Step 324). After the storage of the file is completed, a completion message is transmitted to the image scanner 4 as a document registration response (Step 325). Receiving the completion message from the document management server 2, the image scanner 4 completes the document registration process (Step 326).

Regarding the digital image data of the paper document read by the scanner unit 87 of the image scanner 4 in Step 307, subsequently, the electronic document management system may perform optical character recognition (OCR) so as to extract the document title or the like. By making use of the document title thus extracted and its related information, the document registration processing unit 44 may specify the document folder to register a PDF file. This allows the user to store the PDF file in an optimum document folder, instead of storing the file in a pre-specified document folder, or without pre-specifying any document folder.

In addition, the electronic document management system may display the document title thus extracted and its related information on the console panel of the image scanner or on the display unit of the electronic document terminal. This allows the user to check the name of the document folder to store the PDF file. In this case, the name may be editable by the user. This allows a document folder suitable for the document, to be created automatically in the electronic document management system, so as to store the document in the document folder, without pre-registering a document folder to store a PDF file.

Hereinafter, a further detailed description is given for the above-mentioned embodiment with reference to the accompanying drawings.

(Password Editing)

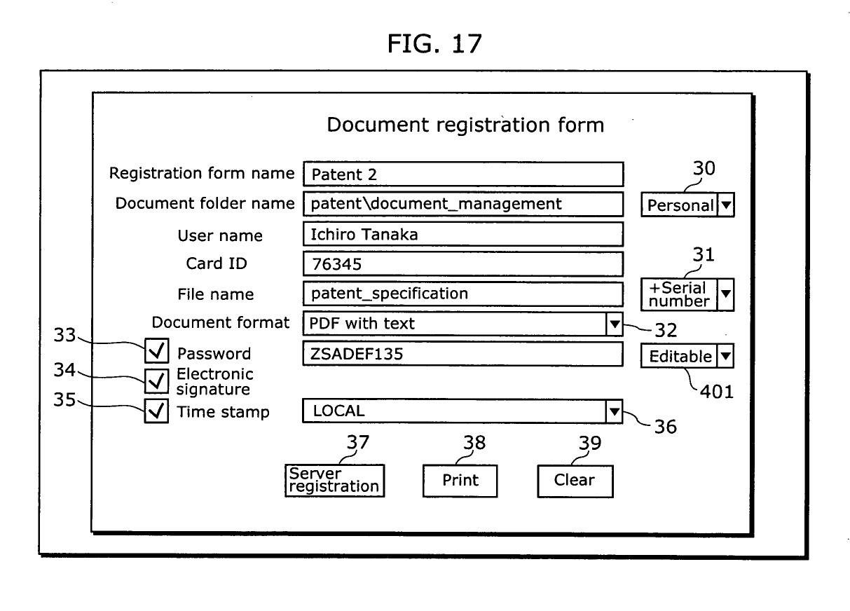

FIG. 17 shows a document registration screen displayed on the display unit 17 of the electronic document terminal 3. On the document registration screen, it is possible to set whether or not a password is editable in the image scanner 4. Specifically, either “EDITABLE” or “UNEDITABLE” is selected in a combo box 401. If “EDITABLE” is selected, the password “ZSADEF135” is editable in the image scanner 4. On the other hand, if “UNEDITABLE” is selected, it becomes impossible to edit the password “ZSADEF135” in the image scanner 4.

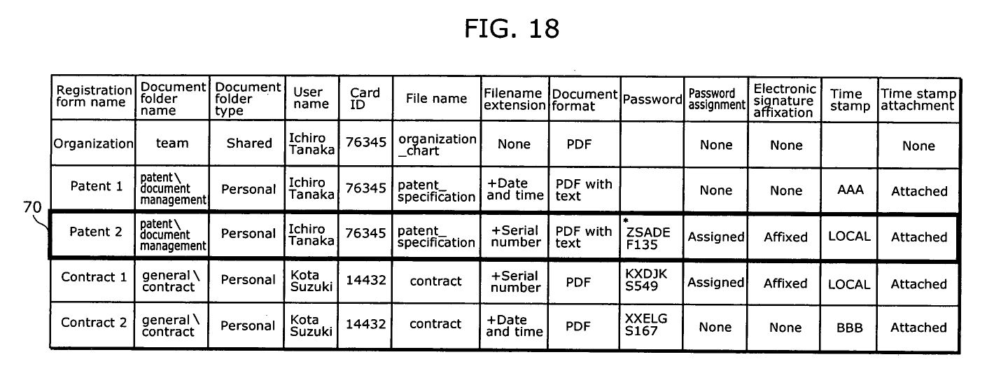

FIG. 18 shows another data structure of the document management database 62. The data structure shown in this figure is the same as in FIG. 8 except that the asterisk “*” is attached to a given value contained in the item “Password”. The asterisk “*” attached to the password “ZSADEF135” means that the password is editable by the user in the image scanner 4. Instead of attaching a marker such as “*” to a password, any other method may be employed as long as the image scanner 4 can determine whether or not the password is editable by the user.

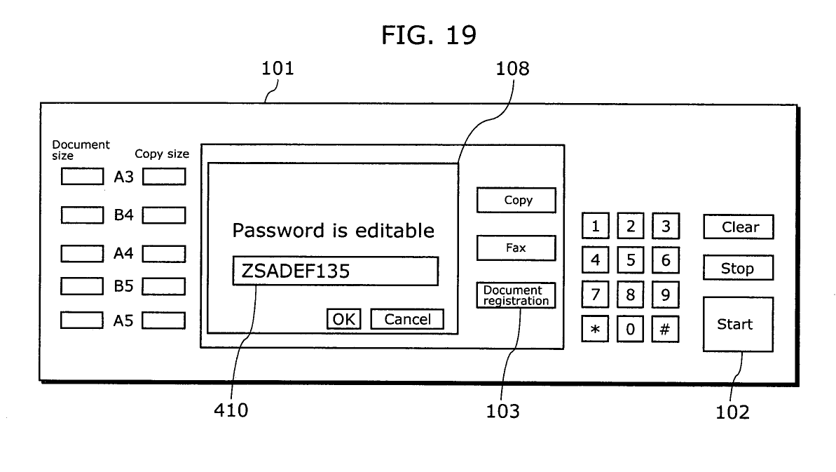

FIG. 19 shows an appearance of the console panel unit 90 of the image scanner 4. The appearance of the console panel unit 90 shown in this figure is the same as in FIG. 11 except that different contents are displayed on the touch panel 108. As has been described with reference to FIG. 11, when the form selection button 104 and the start button 102 of the image scanner 4 are touched, a document management information request message is transmitted from the image scanner 4 to the electronic document management server 2. Subsequently, the registration form names (ORGANIZATION, PATENT 1 and PATENT 2) and the number of registration forms (3) are transmitted from the electronic document management server 2 to the image scanner 4.

Note that the asterisk “*” is attached to the password “ZSADEF135” for the registration form name “PATENT 2” in this case. Therefore, when the registration form names (ORGANIZATION, PATENT 1 AND PATENT 2) and the number of registration forms (3) are transmitted from the electronic document management server 2 to the image scanner 4, the password “ZSADEF135” is also transmitted from the electronic document management server 2 to the image scanner 4.

Let us take an example in which a user selects the registration form name “PATENT 2”. As shown in FIG. 19, the screen allowing the password “ZSADEF135” to be edited is displayed on the touch panel 108. After the password “ZSADEF135” is edited, if an OK button is touched, the password value stored temporarily in the RAM 81 of the image scanner 4 is changed.

In this case, the contents to be displayed on the touch panel 108 are not limited to specific ones, but the screen shown in FIG. 11 should be the initial one to return to. After the screen returns to the state shown in FIG. 11, if a user touches the scanning button 107 and the start button 102, the password which has been edited, is transmitted to the electronic document management server 2, together with TIFF document data (Doc.tiff), the processing command “PutDocument”, the card ID “76345”, and the registration form name (PATENT 2).

The PDF processing unit 45 of the electronic document management server 2 encrypts the part of the PDF data to be obscured, with the edited password as a cryptographic key, so that access control is set on the PDF data using the edited password. Such access control on PDF data using the password which has been just edited in the image scanner 4 is very effective from a security viewpoint.

Instead of the password “ZSADEF135”, the edited password is stored in the document management database 62. Subsequently, another document registration process is performed using the edited password. In this case, it is possible to change the contents of the document management database 62 without the use of the electronic document terminal 3, as a secondary effect. As a matter of course, the password may be edited in the image scanner 4 in such a manner that the edited contents do not affect the document management database 62. In this case, the password edited in the image scanner 4 is available only for a single use.

If “UNEDITABLE” is selected in the combo box 401, even though a user selects the registration form name “PATENT 2” in the same way as above, the screen allowing the password “ZSADEF135” to be edited is not displayed. Specifically, it is impossible to edit the password “ZSADEF135” in the image scanner 4 in this case.

(Editing of Password/Management Number/Comment)

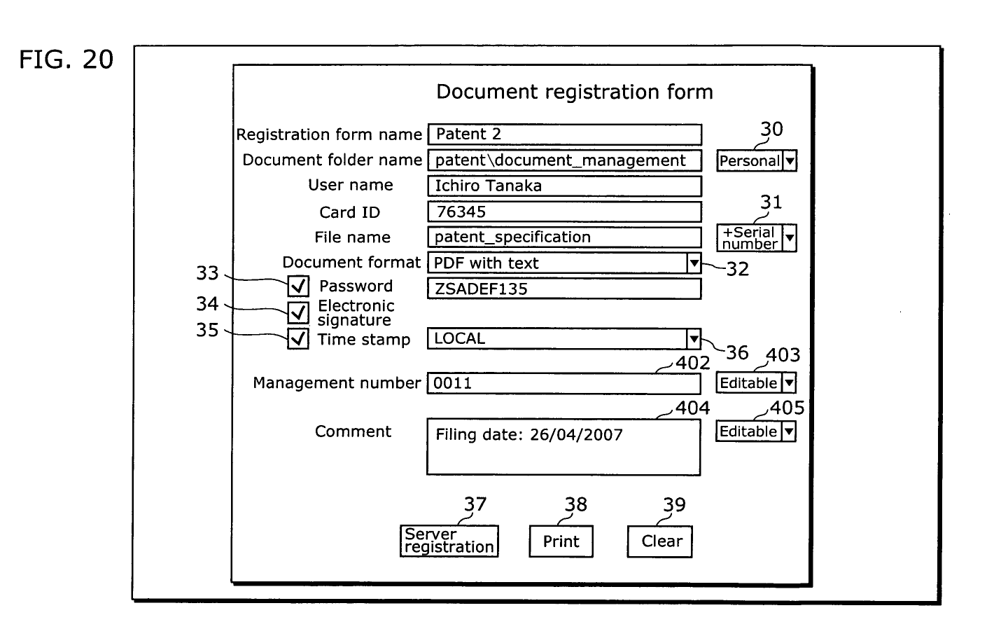

FIG. 20 shows another document registration screen displayed on the display unit 17 of the electronic document terminal 3. On the document registration screen, it is possible to set whether or not a management number 402 and a comment 404 are editable in the image scanner 4, in addition to a password. The management number 402, which is a number to manage an electronic document, shows “0011” as an example. The comment 404, which is a comment on an electronic document, shows “FILING DATE: 26/04/2007” as an example, in this case.

Whether or not the management number 402 is editable is selected in a combo box 403. Specifically, if “EDITABLE” is selected, the management number “0011” is editable in the image scanner 4. On the other hand, “UNEDITABLE” is selected, it becomes impossible to edit the management number “0011” in the image scanner 4.

Similarly, whether or not the comment 404 is editable is selected in a combo box 405. Specifically, if “EDITABLE” is selected, the comment “FILING DATE: 26/04/2007” is editable in the image scanner 4. On the other hand, if “UNEDITABLE” is selected, it becomes impossible to edit the comment “FILING DATE: 26/04/2007” in the image scanner 4.

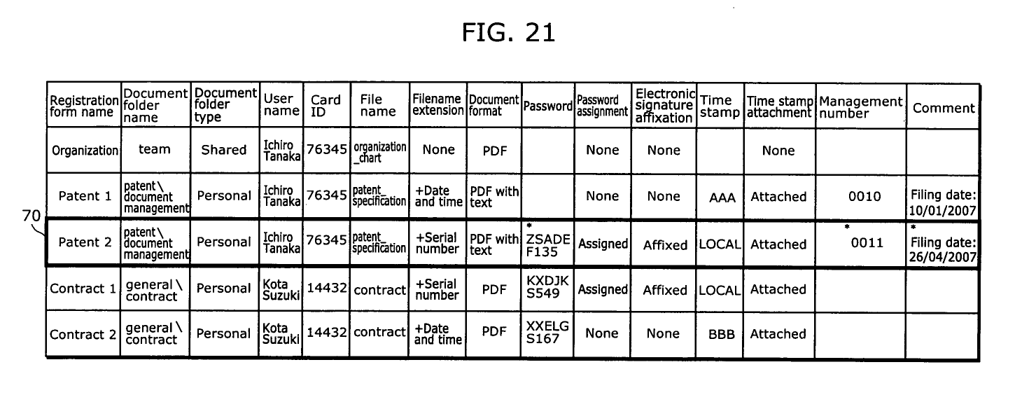

FIG. 21 shows yet another data structure of the document management database 62. The data structure shown in this figure is the same as in FIG. 18 except that the items “Management Number” and “Comment” are added, and that the asterisk “*” is attached to given values contained in the items “Management Number” and “Comment”. The meaning of the asterisk “*” is the same as above, so that its detailed description is omitted here.

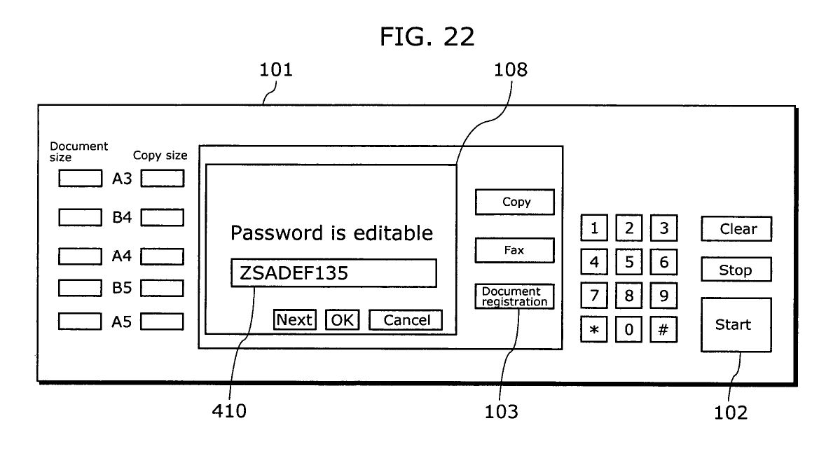

FIG. 22 shows another appearance of the console panel unit 90 of the image scanner 4. The appearance of the console panel unit 90 shown in this figure is the same as in FIG. 19 except that a next button is added to the display contents of the touch panel 108.

In this case, the asterisk “*” is attached to the password “ZSADEF135”, the management number “0011”, and the comment “FILING DATE: 26/04/2007” for the registration form name “PATENT 2”. Therefore, when the registration form names (ORGANIZATION, PATENT 1 and PATENT 2) and the number of registration forms (3) are transmitted from the electronic document management server 2 to the image scanner 4, the password “ZSADEF135”, the management number “0011”, and the comment “FILING DATE: 26/04/2007” are also transmitted from the electronic document management server 2 to the image scanner 4.

Let us take an example in which a user selects the registration form name “PATENT 2”. As shown in FIG. 22, the screen allowing the password “ZSADEF135” to be edited is displayed on the touch panel 108. After the password “ZSADEF135” is edited, if a next button is touched, the password value stored temporarily in the RAM 81 of the image scanner 4 is changed.

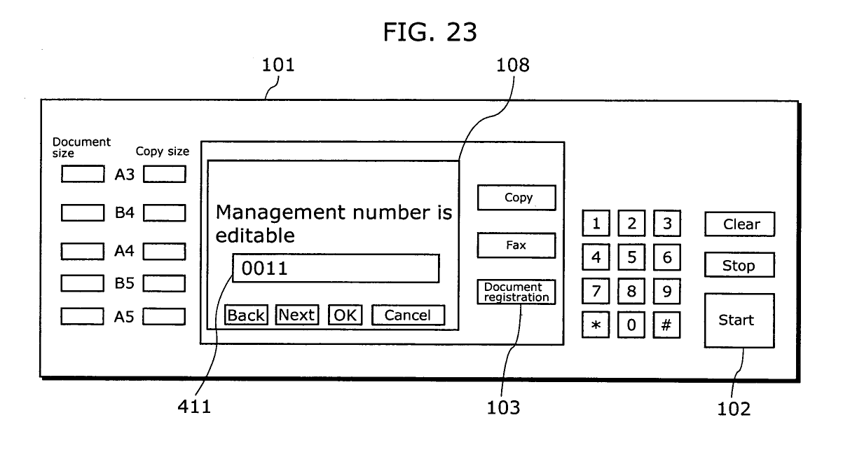

FIG. 23 shows yet another appearance of the console panel unit 90 of the image scanner 4, illustrating the contents displayed on the touch panel 108 immediately after the next button shown in FIG. 22 is touched. As shown in FIG. 23, if the next button shown in FIG. 22 is touched, the screen allowing the management number “0011” to be edited is displayed on the touch panel 108. After the management number “0011” is edited, if the next button is touched, the management number value stored temporarily in the RAM 81 of the image scanner 4 is changed.

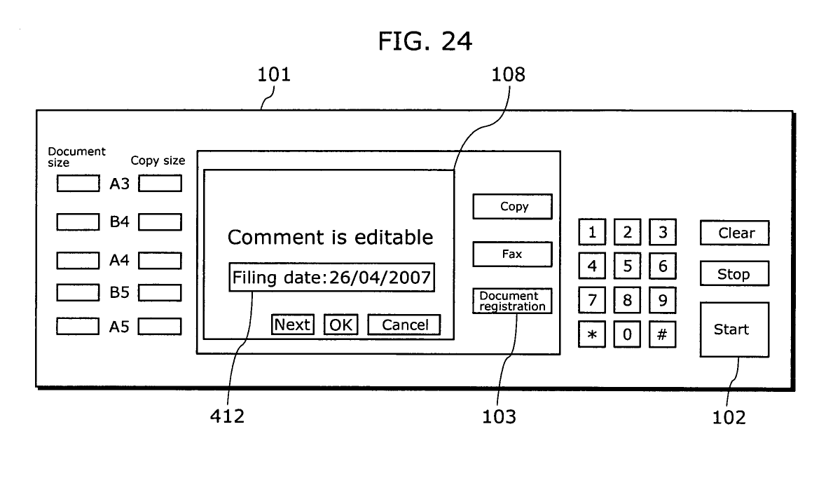

FIG. 24 shows further another appearance of the console panel unit 90 of the image scanner 4, illustrating the contents displayed on the touch panel 108 immediately after the next button shown in FIG. 23 is touched. As shown in FIG. 24, if the next button shown in FIG. 23 is touched, the screen which allows the comment “FILING DATE: 26/04/2007” to be edited is displayed on the touch panel 108. After the comment “FILING DATE: 26/04/2007” is edited, if the OK button is touched, the comment value stored temporarily in the RAM 81 of the image scanner 4 is changed.

In this case, the contents to be displayed on the touch panel 108 are not limited to specific ones, but the screen shown in FIG. 11 should be the initial state to return to. After the screen returns to the state shown in FIG. 11, if a user touches the scanning button 107 and the start button 102, the password, the management number, and the comment which have been edited are transmitted to the electronic document management server 2, together with TIFF document data (Doc.tiff), the processing command (PutDocument), the card ID (76345), and the registration form name (PATENT 2).

The method for processing the edited password in the electronic document management server 2 has been described above. Specifically, the PDF processing unit 45 of the electronic document management server 2 encrypts the part of the PDF data to be obscured, with the edited password as a cryptographic key, so that access control is set on the PDF data using the edited password. Instead of the password “ZSADEF135”, the edited password is stored in the document management database 62.

The edited management number and comment are stored in the document management database 62. Subsequently, another document registration process is performed using the edited management number and comment. In this case, it is possible to change the contents of the document management database 62 without the use of the electronic document terminal 3, as a secondary effect. Similarly to the password case, the management number and comment may be edited in the image scanner 4 in such a manner that the edited contents do not affect the document management database 62.

The document registration processing unit 44 of the electronic document management server 2 may use the edited management number or comment, as a folder name for storing an electronic document, or a file name of an electronic document, or an annotation (comment) added to the PDF data. This allows an electronic document to be retrieved more simply and effectively with the management number or the comment as a retrieval key.

If “UNEDITABLE” is selected in the combo box 403, the screen allowing the management number “0011” to be edited, is not displayed. Specifically, it is impossible to edit the management number “0011” in the image scanner 4 in this case.

Similarly, if “UNEDITABLE” is selected in the combo box 405, the screen allowing the comment “FILING DATE: 26/04/2007” to be edited, is not displayed. Specifically, it is impossible to edit the comment “FILING DATE: 26/04/2007” in the image scanner 4 in this case.

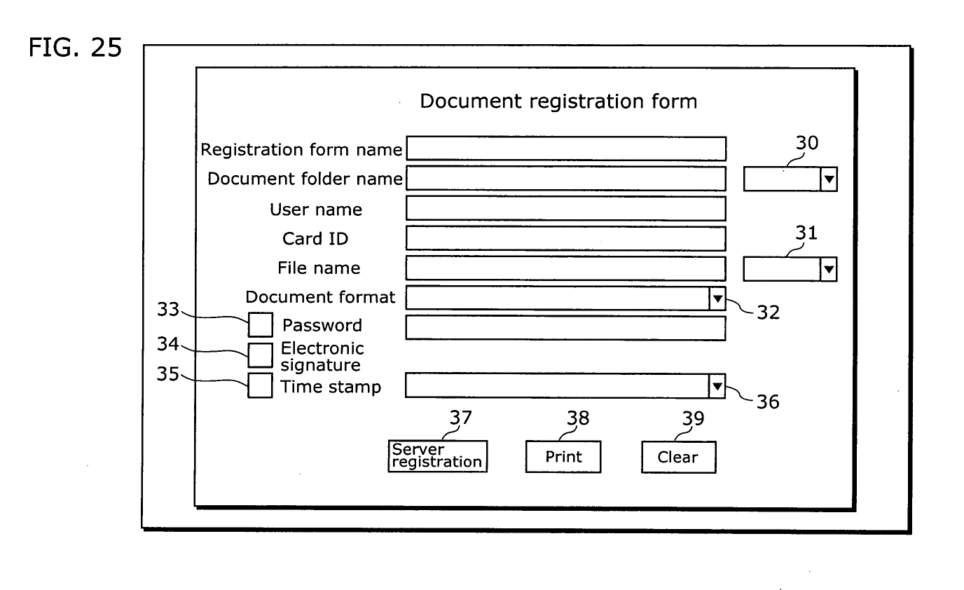

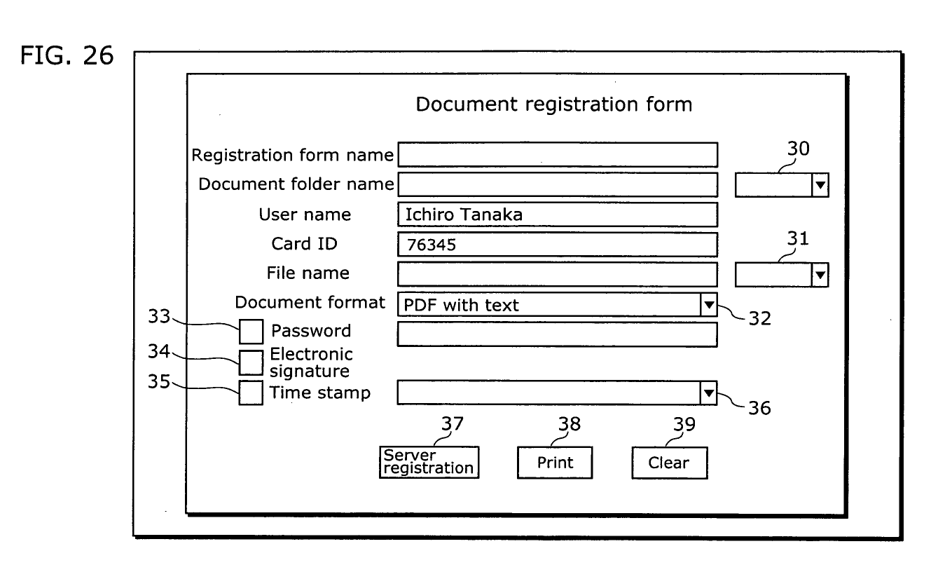

FIG. 25 shows a document registration screen displayed on the display unit 17 of the electronic document terminal 3. In the document registration form in the initial state, although no description has been given so far, each item field is blank. As a matter of course, if the document registration form with entered values is stored in the document management server 2, the stored document registration form may be opened on the document registration screen. In this case, all the pre-entered item values may be copied as shown in FIG. 4. Alternatively, only a specific pre-entered item value may be copied as shown in FIG. 26. This saves a user the trouble of entering information in another document registration form.

FIG. 26 shows an example in which the following pre-entered item values are copied: the user name “Ichiro Tanaka”; the card ID “76345”; and the document format “PDF WITH TEXT”. This example is on the assumption that a given user is named “Ichiro Tanaka”. If another user opens a document registration form, the item values which has been entered before by the same user, appear in the respective form fields.

Although the method for managing document registration forms for each user is not limited to a specific one, it is simple and effective to store a document registration form under a given user's personal folder. For example, since Ichiro Tanaka's card ID is “76345”, Ichiro Tanaka's document registration form is stored in the folder 66 (76345), a subfolder of the personal folder 65. This means, if Ichiro Tanaka logs in the document management server 2, he uses the document registration form stored in the folder 66 (76345).

In this case, as shown in FIG. 3, an account ID, which is different from a card ID, is employed to log in the document management server 2. In order to specify the folder 66 (76345) as Ichiro Tanaka's personal folder, the document management server 2 has to pre-store the correspondence table between card IDs and account IDs. If a card ID is employed to log in the document management server 2 instead of an account ID, the correspondence table between card IDs and account IDs is not required.

Although this example relates to the case in which only the specific items such as a password and a management number are editable in the image scanner 4, all the required items may be set as editable in the image scanner 4. Since user authentication is completed before the editing process starts in the image scanner 4, there arises no problem from a security viewpoint.

If all the items are editable in the image scanner 4, however, an operational problem may arise. Specifically, the console panel of the image scanner 4 is smaller in size than the display unit included in a personal computer, thereby limiting the amount of information displayable at a time. Therefore, if a plurality of items are editable in the image scanner 4, sequential editing such as editing each item value while touching the next button repeatedly is likely to be required (see FIGS. 22 to 24). In this regard, according to the present invention, it is possible to select the item to be edited in advance, thereby minimizing a user's operational burden.

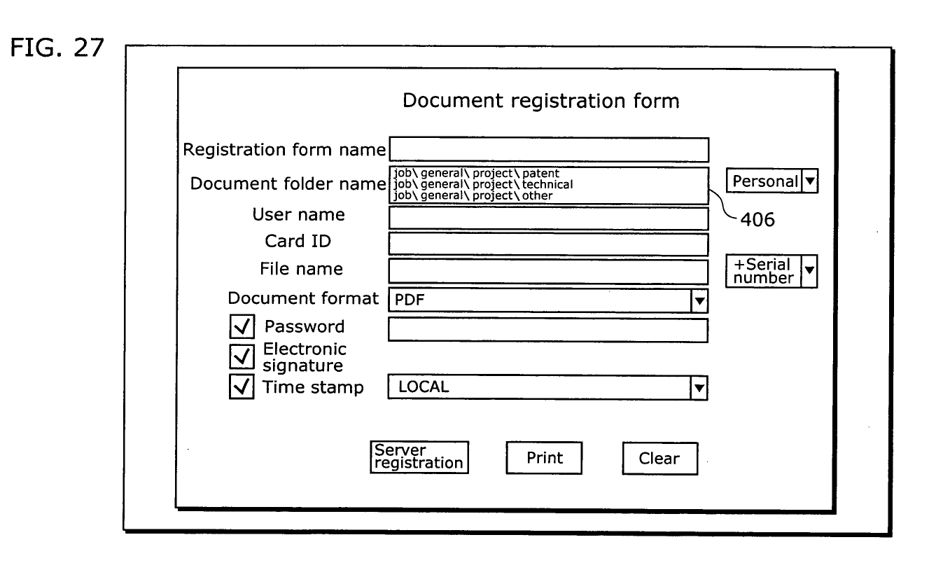

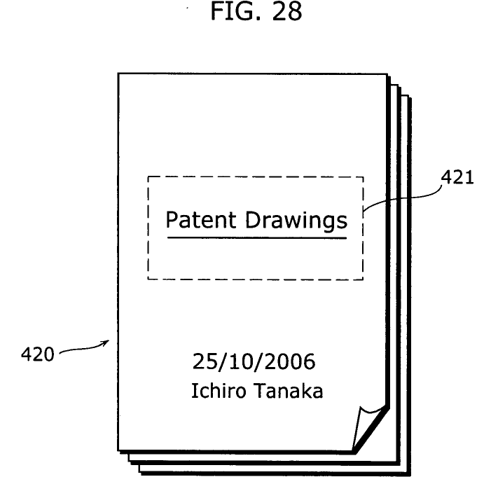

FIG. 27 shows yet another document registration screen displayed on the display unit 17 of the electronic document terminal 3. As shown in this figure, a combo box 406 may be employed for the item “Document Folder Name”. In this case, if the history of the document folder names which have been entered in the combo box 406 is kept therein, the list of the entered document folder names will be available. This allows a required document folder name to be selected from the list, thereby reducing a user's operational burden.

(Image Recognition)

FIG. 28 shows a paper document 420 to be scanned with the image scanner 4. As shown in this figure, within a title area 421 of the paper document 420, the characters “Patent Drawings” are provided. In this case, the document registration processing unit 44 of the document management server 2 recognizes the characters within the title area 421 of the target electronic document. When the character information “Patent Drawings” is obtained in the result, the electronic document is stored with the file name “patent_drawings_{—}0001.pdf” in which the character information is contained.

This example relates to the case in which the document registration processing unit 44 recognizes characters, but the present invention is not limited to this case. In order to obtain a similar effect, the document-layout analysis/character recognition unit 46 may recognize characters to notify the document registration processing unit 44 about the recognition result.

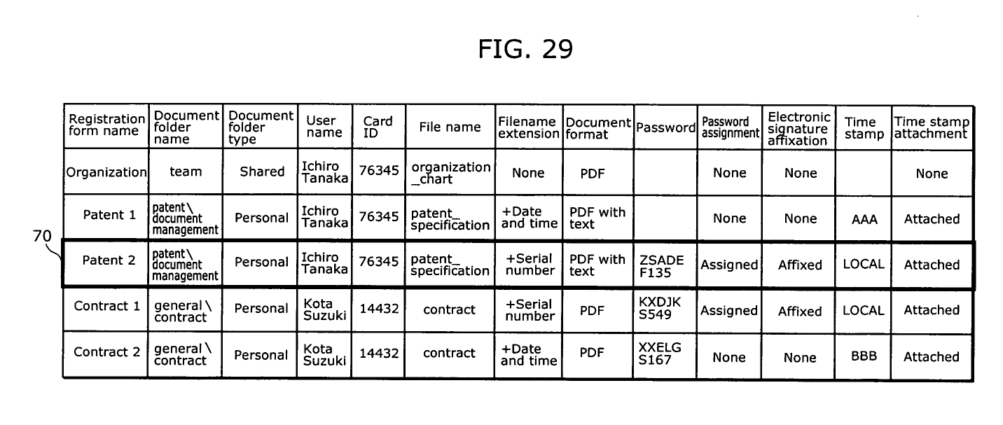

FIG. 29 shows yet another data structure of the document management database 62. The structure is based on the assumption that the character information “Patent Drawings” has been obtained by recognizing the characters within the title area 421 of the electronic document. In this case, the character information “Patent Drawings” is stored in the field “File Name” for the registration form name “PATENT 2”.

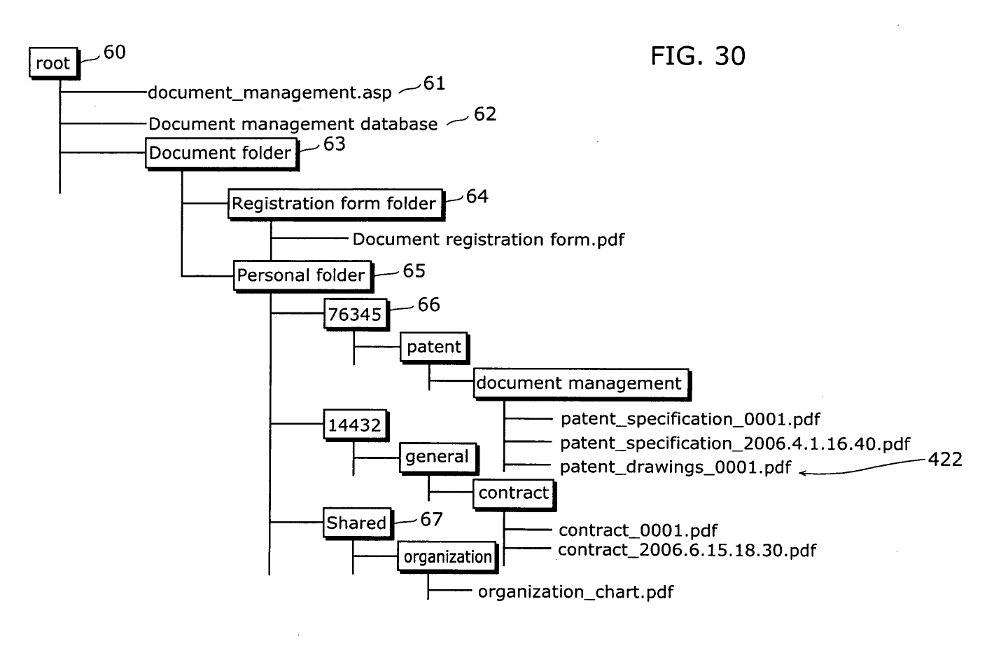

FIG. 30 shows another folder and file structure of the electronic document management server 2. The structure is also based on the assumption that the character information “Patent Drawings” bas been obtained by recognizing the characters within the title area 421 of the electronic document. In this case, PDF data 422 with the file name “patent_drawings_{—}0001.pdf” is stored in the folder “patent\document_management”.

This example relates to the case in which the character information “Patent Drawings” is employed for a file name, but it is only necessary to store the character information “Patent Drawings” in the document management database 62 as part of document management information. For example, the character information “Patent Drawings” may be stored as a value for the item “Document Folder Name”. In this case, the character information “Patent Drawings” is contained in the name of the folder to store the pertinent electronic document.

Although the present invention relates to the case in which an IC card is held over the IC card reader 5 of the image scanner 4 so that authentication is performed, biometric data including fingerprints, an iris, and a voice pattern may also be employed for user authentication. The method with an IC card is similar to the method with biometric data in that the information manually entered with the console panel is not acceptable. Specifically, this is an authentication method capable of preventing spoofing effectively, and accordingly, of great value when tight security is required.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to electronic document management systems having an image scanner such as a digital compound machine.

What is claimed is:

1. An electronic document management system comprising:
an image scanner which optically scans a paper document so as to produce an electronic document based on the scanned paper document; and
an electronic document management server which manages the produced electronic document, wherein:
said electronic document management server includes:
a storage unit operable to store document management information indicating a method for managing the electronic document, in such a manner that the document management information is associated with a management name which is a name of the document management information;
a first transmitting unit operable to transmit the management name stored in said storage unit to said image scanner;
a first receiving unit operable to receive the electronic document together with the management name from said image scanner; and
a processing unit operable to process the electronic document received by said first receiving unit, in accordance with the management method associated with the management name received by said first receiving unit; and
said image scanner includes:
a producing unit operable to produce the electronic document;
a second receiving unit operable to receive the management name from said electronic document management server;
a console panel which allows a user to select a given management name from the management name received by said second receiving unit; and
a second transmitting unit operable to transmit the electronic document produced by said producing unit as well as the management name selected with said console panel, to said electronic document management server.

2. The electronic document management system according to claim 1, wherein:
said image scanner further includes an acquiring unit operable to acquire identification information for identifying the user;
said second transmitting unit is operable to transmit the identification information to said electronic document management server;
said storage unit is operable to store the identification information in such a manner that the identification information is associated with the document management information; and
said first transmitting unit is operable to transmit only the management name associated with the identification information, to said image scanner.

3. The electronic document management system according to claim 2,
wherein said acquiring unit includes a memory reader which reads the identification information stored in an external memory of said electronic document management system.

4. The electronic document management system according to claim 2,
wherein said console panel does not accept manually entered information as the identification information.

5. The electronic document management system according to claim 2, wherein:
said electronic document management server further includes a memory unit operable to store a digital certificate unique to each piece of the identification information;
said storage unit is operable to store, as part of the document management information, signature requirement information which indicates whether or not an electronic signature is required to be affixed to the electronic document; and
said processing unit is operable to affix an electronic signature to the electronic document based on the digital certificate associated with the identification information in the case where the signature requirement information indicates that the electronic signature is required to be affixed.

6. The electronic document management system according to claim 2, wherein:
said storage unit is operable to store folder name information which indicates a destination of the electronic document, as part of the document management information; and
said processing unit is operable to store the electronic document in a folder having a name containing the identification information and the folder name information.

7. The electronic document management system according to claim 1, wherein:
said storage unit is operable to store, as part of the document management information, file name information which indicates a file name of the electronic document, and extension requirement information which indicates whether or not the file name of the electronic document is required to be extended; and
said processing unit is operable to create a file name by adding either serial number information or date/time information to the file name information in the case where the extension requirement information indicates that the file name is required to be extended.

8. The electronic document management system according to claim 1, wherein:
said storage unit is operable to store, as part of the document management information, a password for controlling access to the electronic document, and password requirement information which indicates whether or not the password is required to be assigned to the electronic document; and
said processing unit is operable to set the password stored in said storage unit for the electronic document in the case where the password requirement information indicates that the password is required to be assigned.

9. The electronic document management system according to claim 1, wherein:
said storage unit is operable to store, as part of the document management information, time stamp requirement information which indicates whether or not a time stamp is required to be attached to the electronic document; and
in the case where the time stamp requirement information indicates that the time stamp is required to be attached, said processing unit is operable to access a time-stamping authority so as to obtain a time-stamp token, and attach the obtained time-stamp token to the electronic document.

10. The electronic document management system according to claim 1, wherein:
said first transmitting unit is operable to transmit an item editable by the user to said image scanner, out of item contained in the document management information;
said console panel shows the editable item to the user, and when the user edits the item, said console panel accepts the edited item;
said second transmitting unit is operable to transmit the edited item to said electronic document management server; and
said processing unit is operable to perform a process in accordance with the management method indicated by the edited item.

11. The electronic document management system according to claim 1, wherein:
said first transmitting unit is operable to transmit an item editable by the user to said image scanner, out of item contained in the document management information;
said console panel shows the editable item to the user, and when the user edits the item, said console panel accepts the edited item;
said second transmitting unit is operable to transmit the edited item to said electronic document management server; and
said storage unit is operable to store the edited item as part of the document management information.

12. The electronic document management system according to claim 1, wherein:
said electronic document management server further includes an image recognition unit operable to recognize an image in the electronic document; and
said processing unit is operable to perform a process in accordance with a result of the image recognition.

13. The electronic document management system according to claim 1, wherein:
said electronic document management server further includes an image recognition unit operable to recognize an image in the electronic document; and
said storage unit is operable to store a result of the image recognition as part of the document management information.

14. The electronic document management system according to claim 1, further comprising an electronic document terminal which includes:
a third receiving unit operable to receive, from said electronic document management server, a registration form as a template for registering the document management information;
a display unit operable to display the registration form received by said third receiving unit;
an input unit operable to enter the document management information in the registration form displayed on said display unit; and
a third transmitting unit operable to transmit the registration form to said document management server, the registration form in which the document management information is entered by said input unit.

15. The electronic document management system according to claim 14, wherein:
said third receiving unit is operable to receive the registration form which has been pre-registered;
said display unit is operable to display the registration form which has been pre-registered; and
said input unit is operable to edit contents of the registration form which has been pre-registered.

16. The electronic document management system according to claim 14,
wherein said input unit is operable to allow said image scanner to edit an item selected from item contained in the document management information.

17. An electronic document management server which manages an electronic document, said server comprising:
a storage unit operable to store document management information indicating a method for managing the electronic document, in such a manner that the document management information is associated with a management name which is a name of the document management information;
a first transmitting unit operable to transmit the management name stored in said storage unit to an image scanner;
a first receiving unit operable to receive the electronic document together with the management name from said image scanner; and
a processing unit operable to process the electronic document received by said first receiving unit, in accordance with the management method associated with the management name received by said first receiving unit.

18. An electronic document management method for optically scanning a paper document with an image scanner, producing an electronic document based on the scanned paper document, and managing the produced electronic document in an electronic document management server, wherein:
said method causes the electronic management server to execute the following steps of:
storing document management information indicating a method for managing the electronic document in a storage unit, in such a manner that the document management information is associated with a management name which is a name of the document management information;
transmitting the management name stored in said storage unit to said image scanner;
receiving the electronic document together with the management name from said image scanner; and
processing the electronic document received in said receiving, in accordance with the management method associated with the management name received in said receiving; and
said method causes the image scanner to execute the following steps of:
producing the electronic document;
receiving the management name from said electronic document management server;
selecting a given management name from the management names received in said receiving; and
transmitting the electronic document produced in said producing and the management name selected in said selecting, to said electronic document management server.

19. A program for optically scanning a paper document using an image scanner, producing an electronic document based on the scanned paper document, and managing the produced electronic document in an electronic document management server, wherein:
said program causes the electronic document management server to execute the following steps of:
storing document management information indicating a method for managing the electronic document in a storage unit, in such a manner that the document management information is associated with a management name which is a name of the document management information;
transmitting the management name stored in said storage unit to said image scanner;
receiving the electronic document together with the management name from said image scanner; and
processing the electronic document received in said receiving, in accordance with the management method associated with the management name received in said receiving; and
said program causes the image scanner to execute the following steps of:
producing the electronic document;
receiving the management name from said electronic document management server;
selecting a given management name from the management names received in said receiving; and
transmitting the electronic document produced in said producing and the management name selected in said selecting, to said electronic document management server.
